(19) United States
(12) Patent Application Publication
(10) Pub. No.: US 2026/0203516 A1
(43) Pub. Date: Jul. 16, 2026

(54) SYSTEMS AND METHODS OF FACILITATING GENERATION OF DATA REPRESENTING PATTERNS IN NARRATIVE MEDIA

(71) Applicant: Loomanka LLC, South San Francisco, CA (US)

(72) Inventor: Kathrine Becker, Daly City, CA (US)

(21) Appl. No.: 19/446,644

(22) Filed: Jan. 12, 2026

Related U.S. Application Data
(63) Continuation-in-part of application No. 63/745,165, filed on Jan. 14, 2025.

(51) Int. Cl. G06F 40/30; G06F 16/901

(52) U.S. Cl. CPC G06F 40/30; G06F 16/9024

(57) ABSTRACT

The present disclosure provides a method of facilitating generation of tension maps. Further, the method includes receiving a story data from user devices. Further, the story data indicates stories. Further, the method includes analyzing the story data and determining two or more tension points of the stories based on the analyzing. Further, the two or more tension points correspond to two or more portions of the stories creating a narrative tension for individuals. Further, the method may include generating one or more tension maps of the stories based on the determining. Further, the one or more tension maps correspond to a graphical representation indicating the two or more tension points and one or more relationships between the two or more tension points. Further, the method includes transmitting the one or more tension maps to the user devices associated with users.

### REFERENCE TO RELATED APPLICATIONS

This application claims the benefit of U.S. Provisional Patent Application No. ##/###,###, titled “XXXX”, filed on XXXX, which is incorporated by reference herein in its entirety.

This application is a continuation of U.S. Patent Application No. ##/###,###, titled “XXXX”, filed on XXXX, which is incorporated by reference herein in its entirety.

This application is a continuation of U.S. Patent Application No. ##/###,###, filed on XXXX, which is a continuation of U.S. Patent Application ##/###,###, filed on XXXX, which claims the benefit of U.S. Provisional Patent Application No. ##/###,###, filed on XXXX, each of which is incorporated by reference herein in its entirety.

This application is a national stage application, filed under 35 U.S.C. § 371, of International Patent Application No. PCT/US ####/######, filed on filed on XXXX, which is incorporated by reference herein in its entirety.

### FIELD OF DISCLOSURE

The present disclosure relates to the field of data processing. More specifically, the present disclosure relates to systems and methods of facilitating generation of data representing patterns in narrative media.

### BACKGROUND

The present invention relates generally to the field of computer-implemented systems and methods for the visualization and structural analysis of narrative or literary compositions. The above field is of increasing importance due to the growing reliance on digital authoring platforms, data-driven storytelling tools, and collaborative creative environments. The entertainment and media industry is now laden with more content than may ever be consumed (to the nth degree now) – especially with the rise of generative technologies. In particular, as the entertainment, publishing, and gaming industries continue to adopt computational methods for story development, there arises a significant demand for intelligent systems capable of translating abstract narrative constructs into an intuitive visualization and facilitating navigation of infinite content by creators and audiences to make purchasing and engagement decisions. An effective system should enable users to perceive the evolution of narrative tension, identify relational dependencies between story elements, and understand how individual creative decisions influence the broader narrative flow. Further, the systems should operate efficiently across multiple computing environments, support collaborative interaction among creative stakeholders, and provide meaningful analytical insights derived from narrative data.

However, existing or known systems and tools that attempt to address such creative challenges suffer from a number of technical and practical limitations. Many available writing or story development tools are restricted to static, linear representations that may fail to convey the relational and temporal dynamics inherent in complex narratives. As a result, users may be unable to intuitively discern how narrative tension builds, shifts, or resolves over time. Further, existing graphical visualization techniques may typically be limited to two-dimensional displays that might not adequately represent non-linear, branching, or multi-threaded story structures. The above limitations lead to reduced interpretability and hinder the ability of creators to refine story architecture or assess emotional balance.

In addition, current computational systems lack robust data handling frameworks for modeling the semantic and structural dependencies between narrative elements. Such systems often treat story content as unstructured text. Consequently, modifications to one part of a story frequently require extensive manual updates to dependent sections, increasing the likelihood of inconsistencies and creative inefficiency. Collaborative environments further exacerbate the problems, as simultaneous edits by multiple users may result in synchronization conflicts or loss of contextual meaning.

Further, conventional visualization systems do not adequately address accessibility and usability concerns. Overly dense graphical displays, poor contrast management, and static design layouts make the visualization difficult for users with varying cognitive or perceptual capabilities to interpret the presented data. In collaborative or educational contexts, the deficiency of the conventional visualization system may restrict participation and limit the inclusivity of digital storytelling platforms. Additionally, known systems typically provide minimal analytics or version control, offering limited capacity to track narrative evolution, compare revisions, or measure structural balance across iterations.

Therefore, there is a need for improved systems and methods of facilitating generation of data representing patterns in narrative media that may overcome one or more of the preceding problems.

### SUMMARY OF DISCLOSURE

This summary is provided to introduce a selection of concepts in a simplified form, that are further described below in the Detailed Description. This summary is not intended to identify key features or essential features of the claimed subject matter. Nor is this summary intended to be used to limit the claimed subject matter’s scope.

The present disclosure provides a method of facilitating generation of data representing patterns in narrative media. Further, the method may include receiving, using the communication device, one or more story data from one or more user devices. Further, the one or more story data indicates one or more stories. Further, the method may include analyzing, using a processing device, the one or more story data. Further, the method may include determining, using the processing device, two or more tension points of the one or more stories based on the analyzing of the one or more stories. Further, the two or more tension points correspond to two or more portions of the one or more stories creating a narrative tension for one or more individuals. Further, the method may include generating, using the processing device, one or more tension maps of the one or more stories based on the determining of the two or more tension points. Further, the one or more tension maps correspond to a graphical representation indicating the two or more tension points and one or more relationships between the two or more tension points. Further, the method may include transmitting, using the communication device, the one or more tension maps to the one or more user devices associated with one or more users. Further, the one or more user devices may be configured to present the one or more tension maps.

The present disclosure provides a system for facilitating generation of data representing patterns in narrative media. Further, the system may include a communication device. Further, the communication device may be configured for receiving one or more story data from one or more user devices. Further, the one or more story data indicates one or more stories. Further, the communication device may be configured for transmitting one or more tension maps to the one or more user devices associated with one or more users. Further, the one or more user devices may be configured to present the one or more tension maps. Further, the system may include a processing device communicatively coupled with the processing device. Further, the processing device may be configured for analyzing the one or more story data. Further, the processing device may be configured for determining two or more tension points of the one or more stories based on the analyzing of the one or more stories. Further, the two or more tension points correspond to two or more portions of the one or more stories creating a narrative tension for one or more individuals. Further, the processing device may be configured for generating the one or more tension maps of the one or more stories based on the determining of the two or more tension points. Further, the one or more tension maps correspond to a graphical representation indicating the two or more tension points and one or more relationships between the two or more tension points.

Both the foregoing summary and the following detailed description provide examples and are explanatory only. Accordingly, the foregoing summary and the following detailed description should not be considered to be restrictive. Further, features or variations may be provided in addition to those set forth herein. For example, embodiments may be directed to various feature combinations and sub-combinations described in the detailed description.

### BRIEF DESCRIPTIONS OF DRAWINGS

The accompanying drawings, which are incorporated in and constitute a part of this disclosure, illustrate various embodiments of the present disclosure. The drawings contain representations of various trademarks and copyrights owned by the Applicants. In addition, the drawings may contain other marks owned by third parties and are being used for illustrative purposes only. All rights to various trademarks and copyrights represented herein, except those belonging to their respective owners, are vested in and the property of the applicants. The applicants retain and reserve all rights in their trademarks and copyrights included herein, and grant permission to reproduce the material only in connection with reproduction of the granted patent and for no other purpose.

Furthermore, the drawings may contain text or captions that may explain certain embodiments of the present disclosure. This text is included for illustrative, non-limiting, explanatory purposes of certain embodiments detailed in the present disclosure.

FIG. 1 is an illustration of an online platform 100 consistent with various embodiments of the present disclosure.

FIG. 2 is a block diagram of a computing device 200 for implementing the methods disclosed herein, in accordance with some embodiments.

FIG. 3 illustrates a flowchart of a method 300 of facilitating generation of data representing patterns in narrative media, in accordance with some embodiments.

FIG. 4 illustrates a flowchart of a method 400 of facilitating generation of data representing patterns in narrative media including analyzing, using the processing device 904, the at least one metadata, in accordance with some embodiments.

FIG. 5 illustrates a flowchart of a method 500 of facilitating generation of data representing patterns in narrative media including obtaining, using the processing device 904, at least one tension set, in accordance with some embodiments.

FIG. 6 illustrates a flowchart of a method 600 of facilitating generation of data representing patterns in narrative media including receiving, using the communication device 902, the at least one preference data from the at least one user device, in accordance with some embodiments.

FIG. 7 illustrates a flowchart of a method 700 of facilitating generation of data representing patterns in narrative media including generating, using the processing device 904, a template data, in accordance with some embodiments.

FIG. 8 illustrates a flowchart of a method 800 of facilitating generation of data representing patterns in narrative media including generating, using the processing device 904, at least one edit suggestion data using the AI model, in accordance with some embodiments.

FIG. 9 illustrates a block diagram of a system 900 of facilitating generation of data representing patterns in narrative media, in accordance with some embodiments.

FIG. 10 illustrates a flowchart of a method 1000 of facilitating generation of data representing patterns in narrative media including generating, using the processing device 904, an analytics data of the at least one tension set, in accordance with some embodiments.

FIG. 11 illustrates a flowchart of a method 1100 of facilitating generation of data representing patterns in narrative media including generating, using the processing device 904, at least one prompt data, in accordance with some embodiments.

FIG. 12 illustrates a flowchart of a method 1200 of facilitating generation of data representing patterns in narrative media including generating, using the processing device 904, at least one metadata request, in accordance with some embodiments.

FIG. 13 illustrates a flowchart of a method 1300 of facilitating generation of data representing patterns in narrative media including receiving, using the communication device 902, at least one note data from the at least one user device, in accordance with some embodiments.

FIG. 14 illustrates a flowchart of a method 1400 of facilitating generation of data representing patterns in narrative media including generating, using the processing device 904, a Graphical User Interface (GUI) data, in accordance with some embodiments.

FIG. 15 illustrates a flowchart of a method 1500 of facilitating generation of data representing patterns in narrative media including generating, using the processing device 904, a plurality of note card data for the plurality of additional details, in accordance with some embodiments.

FIG. 16 illustrates a flowchart of a method 1600 of facilitating generation of data representing patterns in narrative media including retrieving, using the storage device, at least one of the plurality of additional details, in accordance with some embodiments.

FIG. 17 illustrates a flowchart of a method 1700 of facilitating generation of data representing patterns in narrative media including receiving, using the communication device 902, at least one paused data from the at least one user device, in accordance with some embodiments.

FIG. 18 illustrates a flowchart of a method 1800 of facilitating generation of data representing patterns in narrative media including generating, using the processing device 904, a plurality of pause card data for the plurality of paused details, in accordance with some embodiments.

FIG. 19 illustrates a flowchart of a method 1900 of facilitating generation of data representing patterns in narrative media including retrieving, using the storage device, at least one of the plurality of paused details, in accordance with some embodiments.

FIG. 20 illustrates a flowchart of a method 2000 of facilitating generation of data representing patterns in narrative media including receiving, using the communication device 902, at least one tension point data from the at least one user device, in accordance with some embodiments.

FIG. 21 illustrates a flowchart of a method 2100 of facilitating generation of data representing patterns in narrative media including generating, using the processing device 904, a modified template data, in accordance with some embodiments.

FIG. 22 illustrates a flowchart of a method 2200 of facilitating generation of data representing patterns in narrative media including generating, using the processing device 904, at least one modified tension map, in accordance with some embodiments.

FIG. 23 illustrates a flowchart of a method 2300 of facilitating generation of data representing patterns in narrative media including allowing, using the processing device 904, at least one functionality, in accordance with some embodiments.

FIG. 24 illustrates a Graphical User Interface (GUI) 2400 of a system of facilitating generation of data representing patterns in narrative media, in accordance with some embodiments.

FIG. 25 illustrates a story focus Graphical User Interface (GUI) 2500 of the system of facilitating generation of data representing patterns in narrative media, in accordance with some embodiments.

FIG. 26 illustrates a tension set focus Graphical User Interface (GUI) 2600 of the system of facilitating generation of data representing patterns in narrative media, in accordance with some embodiments.

FIG. 27 illustrates a Graphical User Interface (GUI) 2700 of the system facilitating generation of data representing patterns in narrative media, displaying a note function, in accordance with some embodiments.

FIG. 28 illustrates a Graphical User Interface (GUI) 2800 of the system facilitating generation of data representing patterns in narrative media, displaying a recorded user note, in accordance with some embodiments.

FIG. 29 illustrates a Graphical User Interface (GUI) 2900 of the system facilitating generation of data representing patterns in narrative media, displaying a parking lot function, in accordance with some embodiments.

FIG. 30 illustrates a first creator suite Graphical User Interface (GUI) 3000 of the system of facilitating generation of data representing patterns in narrative media, in accordance with some embodiments.

FIG. 31 illustrates a second creator suite Graphical User Interface (GUI) 3100 of the system of facilitating generation of data representing patterns in narrative media, in accordance with some embodiments.

FIG. 32 illustrates a third creator suite Graphical User Interface (GUI) 3200 of the system of facilitating generation of data representing patterns in narrative media, in accordance with some embodiments.

FIG. 33 illustrates a fourth creator suite Graphical User Interface (GUI) 3300 of the system of facilitating generation of data representing patterns in narrative media, in accordance with some embodiments.

FIG. 34 illustrates a fifth creator suite Graphical User Interface (GUI) 3400 of the system of facilitating generation of data representing patterns in narrative media, in accordance with some embodiments.

FIG. 35 illustrates an open-close tension set 3500 of the system of facilitating generation of data representing patterns in narrative media, in accordance with some embodiments.

FIG. 36 illustrates an open-continue-close tension set 3600 of the system of facilitating generation of data representing patterns in narrative media, in accordance with some embodiments.

FIG. 37A is a first representation of an incomplete tension set 3700 of the system of facilitating generation of data representing patterns in narrative media, in accordance with some embodiments.

FIG. 37B is a second representation of the incomplete tension set 3700 of the system of facilitating generation of data representing patterns in narrative media, in accordance with some embodiments.

FIG. 38 illustrates a milieu bubble tension set 3800 of the system of facilitating generation of data representing patterns in narrative media, in accordance with some embodiments.

FIG. 39A illustrates a mobile Graphical User Interface (GUI) 3900 depicting a transition of tension points, in accordance with some embodiments.

FIG. 39B illustrates the mobile Graphical User Interface (GUI) 3900 depicting the transition of tension points, in accordance with some embodiments.

FIG. 39C illustrates the mobile Graphical User Interface (GUI) 3900 depicting the transition of tension points, in accordance with some embodiments.

FIG. 39D illustrates the mobile Graphical User Interface (GUI) 3900 depicting the transition of tension points, in accordance with some embodiments.

FIG. 40 illustrates a mobile Graphical User Interface (GUI) 4000 displaying a graphical card, in accordance with some embodiments.

FIG. 41 illustrates a mobile Graphical User Interface (GUI) 4100 displaying a user note, in accordance with some embodiments.

FIG. 42 illustrates a Graphical User Interface (GUI) 4200 of the system of facilitating generation of data representing patterns in narrative media, displaying a three-dimensional model, in accordance with some embodiments.

### DETAILED DESCRIPTION OF DISCLOSURE

As a preliminary matter, it will readily be understood by one having ordinary skill in the relevant art that the present disclosure has broad utility and application. As should be understood, any embodiment may incorporate only one or a plurality of the above-disclosed aspects of the disclosure and may further incorporate only one or a plurality of the above-disclosed features. Furthermore, any embodiment discussed and identified as being “preferred” is considered to be part of a best mode contemplated for carrying out the embodiments of the present disclosure. Other embodiments also may be discussed for additional illustrative purposes in providing a full and enabling disclosure. Moreover, many embodiments, such as adaptations, variations, modifications, and equivalent arrangements, will be implicitly disclosed by the embodiments described herein and fall within the scope of the present disclosure.

Accordingly, while embodiments are described herein in detail in relation to one or more embodiments, it is to be understood that this disclosure is illustrative and exemplary of the present disclosure, and are made merely for the purposes of providing a full and enabling disclosure. The detailed disclosure herein of one or more embodiments is not intended, nor is to be construed, to limit the scope of patent protection afforded in any claim of a patent issuing here from, which scope is to be defined by the claims and the equivalents thereof. It is not intended that the scope of patent protection be defined by reading into any claim limitation found herein and/or issuing here from that does not explicitly appear in the claim itself.

Thus, for example, any sequence(s) and/or temporal order of steps of various processes or methods that are described herein are illustrative and not restrictive. Accordingly, it should be understood that, although steps of various processes or methods may be shown and described as being in a sequence or temporal order, the steps of any such processes or methods are not limited to being carried out in any particular sequence or order, absent an indication otherwise. Indeed, the steps in such processes or methods generally may be carried out in various different sequences and orders while still falling within the scope of the present disclosure. Accordingly, it is intended that the scope of patent protection is to be defined by the issued claim(s) rather than the description set forth herein.

Additionally, it is important to note that each term used herein refers to that which an ordinary artisan would understand such term to mean based on the contextual use of such term herein. To the extent that the meaning of a term used herein—as understood by the ordinary artisan based on the contextual use of such term—differs in any way from any particular dictionary definition of such term, it is intended that the meaning of the term as understood by the ordinary artisan should prevail.

Furthermore, it is important to note that, as used herein, “a” and “an” each generally denotes “at least one,” but does not exclude a plurality unless the contextual use dictates otherwise. When used herein to join a list of items, “or” denotes “at least one of the items,” but does not exclude a plurality of items of the list. Finally, when used herein to join a list of items, “and” denotes “all of the items of the list.”

The following detailed description refers to the accompanying drawings. Wherever possible, the same reference numbers are used in the drawings and the following description to refer to the same or similar elements. While many embodiments of the disclosure may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the disclosure. Instead, the proper scope of the disclosure is defined by the claims found herein and/or issuing here from. The present disclosure contains headers. It should be understood that these headers are used as references and are not to be construed as limiting upon the subject matter disclosed under the header.

The present disclosure includes many aspects and features. Moreover, while many aspects and features relate to, and are described in the context of the disclosed use cases, embodiments of the present disclosure are not limited to use only in this context.

In general, the method disclosed herein may be performed by one or more computing devices. For example, in some embodiments, the method may be performed by a server computer in communication with one or more client devices over a communication network such as, for example, the Internet. In some other embodiments, the method may be performed by one or more of at least one server computer, at least one client device, at least one network device, at least one sensor and at least one actuator. Examples of the one or more client devices and/or the server computer may include, a desktop computer, a laptop computer, a tablet computer, a personal digital assistant, a portable electronic device, a wearable computer, a smart phone, an Internet of Things (IoT) device, a smart electrical appliance, a video game console, a rack server, a super-computer, a mainframe computer, mini-computer, micro-computer, a storage server, an application server (e.g. a mail server, a web server, a real-time communication server, an FTP server, a virtual server, a proxy server, a DNS server etc.), a quantum computer, and so on. Further, one or more client devices and/or the server computer may be configured for executing a software application such as, for example, but not limited to, an operating system (e.g. Windows, Mac OS, Unix, Linux, Android, etc.) in order to provide a user interface (e.g. GUI, touch-screen based interface, voice based interface, gesture based interface etc.) for use by the one or more users and/or a network interface for communicating with other devices over a communication network. Accordingly, the server computer may include a processing device configured for performing data processing tasks such as, for example, but not limited to, analyzing, identifying, determining, generating, transforming, calculating, computing, compressing, decompressing, encrypting, decrypting, scrambling, splitting, merging, interpolating, extrapolating, redacting, anonymizing, encoding and decoding. Further, the server computer may include a communication device configured for communicating with one or more external devices. The one or more external devices may include, for example, but are not limited to, a client device, a third party database, public database, a private database and so on. Further, the communication device may be configured for communicating with the one or more external devices over one or more communication channels. Further, the one or more communication channels may include a wireless communication channel and/or a wired communication channel. Accordingly, the communication device may be configured for performing one or more of transmitting and receiving of information in electronic form. Further, the server computer may include a storage device configured for performing data storage and/or data retrieval operations. In general, the storage device may be configured for providing reliable storage of digital information. Accordingly, in some embodiments, the storage device may be based on technologies such as, but not limited to, data compression, data backup, data redundancy, deduplication, error correction, data finger-printing, role based access control, and so on.

Further, one or more steps of the method disclosed herein may be initiated, maintained, controlled and/or terminated based on a control input received from one or more devices operated by one or more users such as, for example, but not limited to, an end user, an admin, a service provider, a service consumer, an agent, a broker and a representative thereof. Further, the user as defined herein may refer to a human, an animal or an artificially intelligent being in any state of existence, unless stated otherwise, elsewhere in the present disclosure. Further, in some embodiments, the one or more users may be required to successfully perform authentication in order for the control input to be effective. In general, a user of the one or more users may perform authentication based on the possession of a secret human readable secret data (e.g. username, password, passphrase, PIN, secret question, secret answer etc.) and/or possession of a machine readable secret data (e.g. encryption key, decryption key, bar codes, etc.) and/or or possession of one or more embodied characteristics unique to the user (e.g. biometric variables such as, but not limited to, fingerprint, palm-print, voice characteristics, behavioral characteristics, facial features, iris pattern, heart rate variability, evoked potentials, brain waves, and so on) and/or possession of a unique device (e.g. a device with a unique physical and/or chemical and/or biological characteristic, a hardware device with a unique serial number, a network device with a unique IP/MAC address, a telephone with a unique phone number, a smartcard with an authentication token stored thereupon, etc.). Accordingly, the one or more steps of the method may include communicating (e.g. transmitting and/or receiving) with one or more sensor devices and/or one or more actuators in order to perform authentication. For example, the one or more steps may include receiving, using the communication device, the secret human readable data from an input device such as, for example, a keyboard, a keypad, a touch-screen, a microphone, a camera and so on. Likewise, the one or more steps may include receiving, using the communication device, the one or more embodied characteristics from one or more biometric sensors.

Further, one or more steps of the method may be automatically initiated, maintained and/or terminated based on one or more predefined conditions. In an instance, the one or more predefined conditions may be based on one or more contextual variables. In general, the one or more contextual variables may represent a condition relevant to the performance of the one or more steps of the method. The one or more contextual variables may include, for example, but are not limited to, location, time, identity of a user associated with a device (e.g. the server computer, a client device etc.) corresponding to the performance of the one or more steps, environmental variables (e.g. temperature, humidity, pressure, wind speed, lighting, sound, etc.) associated with a device corresponding to the performance of the one or more steps, physical state and/or physiological state and/or psychological state of the user, physical state (e.g. motion, direction of motion, orientation, speed, velocity, acceleration, trajectory, etc.) of the device corresponding to the performance of the one or more steps and/or semantic content of data associated with the one or more users. Accordingly, the one or more steps may include communicating with one or more sensors and/or one or more actuators associated with the one or more contextual variables. For example, the one or more sensors may include, but are not limited to, a timing device (e.g. a real-time clock), a location sensor (e.g. a GPS receiver, a GLONASS receiver, an indoor location sensor etc.), a biometric sensor (e.g. a fingerprint sensor), an environmental variable sensor (e.g. temperature sensor, humidity sensor, pressure sensor, etc.) and a device state sensor (e.g. a power sensor, a voltage/current sensor, a switch-state sensor, a usage sensor, etc. associated with the device corresponding to performance of the or more steps).

Further, the one or more steps of the method may be performed one or more number of times. Additionally, the one or more steps may be performed in any order other than as exemplarily disclosed herein, unless explicitly stated otherwise, elsewhere in the present disclosure. Further, two or more steps of the one or more steps may, in some embodiments, be simultaneously performed, at least in part. Further, in some embodiments, there may be one or more time gaps between performance of any two steps of the one or more steps.

Further, in some embodiments, the one or more predefined conditions may be specified by the one or more users. Accordingly, the one or more steps may include receiving, using the communication device, the one or more predefined conditions from one or more and devices operated by the one or more users. Further, the one or more predefined conditions may be stored in the storage device. Alternatively, and/or additionally, in some embodiments, the one or more predefined conditions may be automatically determined, using the processing device, based on historical data corresponding to performance of the one or more steps. For example, the historical data may be collected, using the storage device, from a plurality of instances of performance of the method. Such historical data may include performance actions (e.g. initiating, maintaining, interrupting, terminating, etc.) of the one or more steps and/or the one or more contextual variables associated therewith. Further, machine learning may be performed on the historical data in order to determine the one or more predefined conditions. For instance, machine learning on the historical data may determine a correlation between one or more contextual variables and performance of the one or more steps of the method. Accordingly, the one or more predefined conditions may be generated, using the processing device, based on the correlation.

Further, one or more steps of the method may be performed at one or more spatial locations. For instance, the method may be performed by a plurality of devices interconnected through a communication network. Accordingly, in an example, one or more steps of the method may be performed by a server computer. Similarly, one or more steps of the method may be performed by a client computer. Likewise, one or more steps of the method may be performed by an intermediate entity such as, for example, a proxy server. For instance, one or more steps of the method may be performed in a distributed fashion across the plurality of devices in order to meet one or more objectives. For example, one objective may be to provide load balancing between two or more devices. Another objective may be to restrict a location of one or more of an input data, an output data and any intermediate data there between corresponding to one or more steps of the method. For example, in a client-server environment, sensitive data corresponding to a user may not be allowed to be transmitted to the server computer. Accordingly, one or more steps of the method operating on the sensitive data and/or a derivative thereof may be performed at the client device.

### Overview:

The present disclosure describes a system and method for facilitating the visualization of literary devices. Further, the present disclosure describes the system and method for facilitating generation of data representing patterns in narrative media. Further, the disclosed system and method may allow the graphical representation of different literary devices of a story to enable the user to better monitor and develop the story. In the preferred embodiment, the disclosed system may be implemented as a computing system that may enable the user to access the functionalities disclosed in the present disclosure using the appropriate computing device.

The entertainment and media industry is now laden with more content than may ever be consumed (to the nth degree now) – especially with the rise of generative technologies. The disclosed system and method not only enables creative development of individual stories, they also help creators and audiences to navigate the landscape of infinite content as the creators and the audiences make purchasing and engagement decisions. Example moments of judgment are: when a studio needs to make a purchasing decision, when a viewer decides whether or not to watch a show, and when a reader decides whether or not to read material.

Further, the disclosed tension map concept is basically a new metric and a new way to measure what makes a story. Further, the tension map data may be used in a narrow way to develop individual stories, or the tension map data may be applied to entire libraries as users decide how to engage with narrative media. E.g., if viewers could see tension map data for every television show, the viewers may be able to make viewing decisions based on the newly visible dimension of narrative tension.

Further, the disclosed system may generally include at least one user account managed by at least one remote server. Further, the user account may enable the corresponding user to access the functionalities disclosed in the present disclosure. Each user account may provide the corresponding user with the appropriate functionalities according to the user’s authorized access. For example, end users may be given access to the features that allow the creation, editing, sharing, etc., of the corresponding tension maps. Further, the user account may be associated with a corresponding user computing device that allows the user to access the functionalities disclosed in the present disclosure via a software application installed on the user computing device.

In the preferred embodiment, the user computing device may be any computing device with a user interface and an Internet connection to connect to the remote server. For example, the user computing device may include, but is not limited to, a smartphone, a personal computer, etc. Likewise, the software application may be developed in different versions that are compatible with the different computing devices that the user may utilize. The system’s software application may be provided as a mobile application, a desktop application, a web application, etc. For example, the system’s software application may be provided as a web application accessible through common web browsers on a smartphone, laptop, desktop computer, etc. However, device-specific versions of the software application may be developed as well. Further, the system may function with third-party services to further facilitate the monitoring and development of the desired story. Furthermore, the different processes of the disclosed method may be performed locally at the user computing device, remotely at the remote server, depending on the computing capabilities of the user computing device, or a combination thereof.

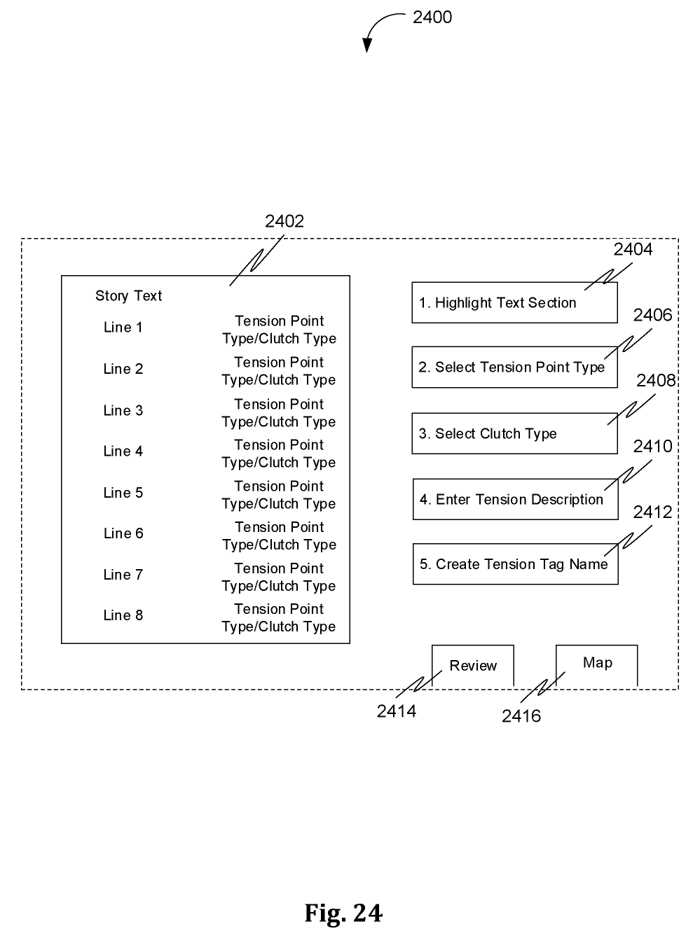

As may be seen in FIG. 24, the system may enable the uploading of an existing story for processing in order to enable the generation of the corresponding tension maps. Further, the tension map is intended to create a representation of all setups and payoffs in a story (there may be hundreds). Further, a single tension set represents a group of tension points, usually a setup and payoff. Further, the tension point is an individual setup or payoff. In the preferred embodiment, the software application may include an upload module that facilitates the uploading of a story file. The upload module may include different mechanisms that accommodate several file formats which were originally used to create the story file. The upload module may also facilitate the conversion of the story file to the appropriate file format that may be used by the disclosed system. Further, the software application may include several uploading functions that allow the user to manipulate the story file prior to starting the creation of the tension map. The upload module may allow a specific process of uploading and processing a story file with the user computing device and/or the remote server to generate at least one tension map for the uploaded story.

As may be seen in FIG. 24, the overall process of uploading and processing a story file may include the steps of prompting the user account to upload at least one story file with the user computing device. The Graphical User Interface (GUI) of the software application may include an upload page that guides the user through the upload process using different graphical features such as text messages providing instructions or information about compatible file formats. Once the story file has been uploaded and processed, the user computing device displays the story in text format along with a plurality of mapping functions that guide the user through the creation of the tension map. In general, the software application’s GUI displays the text story adjacent to the mapping functions so that the user may perform the mapping steps in the same order that mapping functions are displayed. However, in other embodiments, the text story and the mapping functions may be displayed in different manners on the user computing device according to the device’s display capabilities.

After the story text and the mapping functions may be displayed on the user computing device, the user account may be prompted to mark up at least one text selection using the user computing device. As may be seen in FIG. 24, the user may manually mark several text selections on the story text using the user interface of the user computing device. The mark ups may be graphically displayed by the user computing device using different graphical mechanisms, such as highlighting the selected text. Then, the user account may be prompted to enter selection information for each of the text selections with the user computing device.

In the preferred embodiment, the user may enter different information and metadata for the selected story text that may be used to categorize and help map the corresponding tension map. For example, the user may be prompted to confirm the text selection, select the type of tension corresponding to the text selection, select a clutch type (i.e. subset of tension and release pairs), input a tension description, create a one-ward tag for the tension set, etc.

Further, the system may include different types of tension points to help create the corresponding tension map. For example, the types of tension points may include, but are not limited to, moments in the story where a conflict begins, moments in the story when tension is heightened, moments in the story where the conflict is resolved, etc. Similarly, different types of clutches may be implemented including, but not limited to, problem/solution, setup/payoff, mystery/reveal, conflict/resolution, expectation set/expectation reveal, risk/safety, attempt/success, attempt/fail, etc.

Further, tension sets correspond to groups of tension points that are connected to each other due to the corresponding tags. Once the user has finished marking up the desired text of the story and entering the corresponding metadata, the corresponding data may be relayed from the user computing device to the remote server for storage. In other embodiments, different functionalities may be implemented to further process the uploaded story file using the system.

In the preferred embodiment, after the user has marked up the entire story file, the user account may be prompted to review the markup or to proceed with the mapping process with the user computing device. If the user may choose to review the markup, the user computing device may display the story text with all the markup graphically superimposed on the story text for the user to review. The user computing device may provide editing functionality for the user to select if the user needs to edit any of the selected text. Once the markup review may be completed or if the user chooses to directly process with the mapping process, the metadata is processed, and each of the tension points may be displayed as a graphical card on the user computing device.

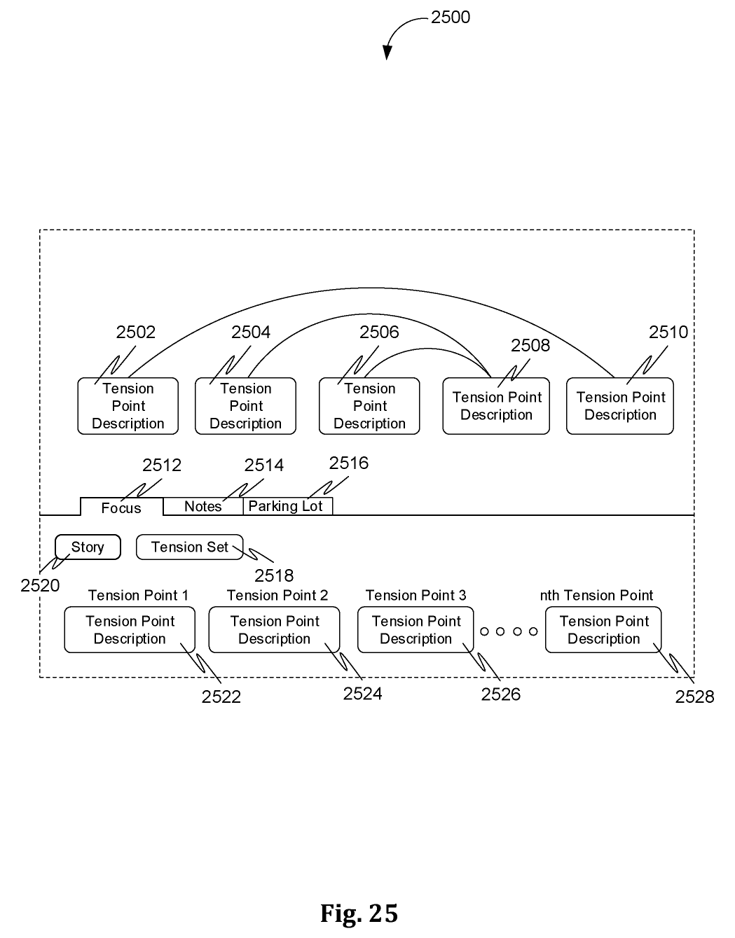

As may be seen in FIG. 25 through 29, the graphical cards may be preferably displayed as rectangles with rounded corners on the display of the user computing device. In addition, the user computing device may display the connections as solid lines between the corresponding pairs of tension points. In other embodiments, the tension points and the corresponding connections may be graphically displayed on the user computing device using different graphical mechanisms.

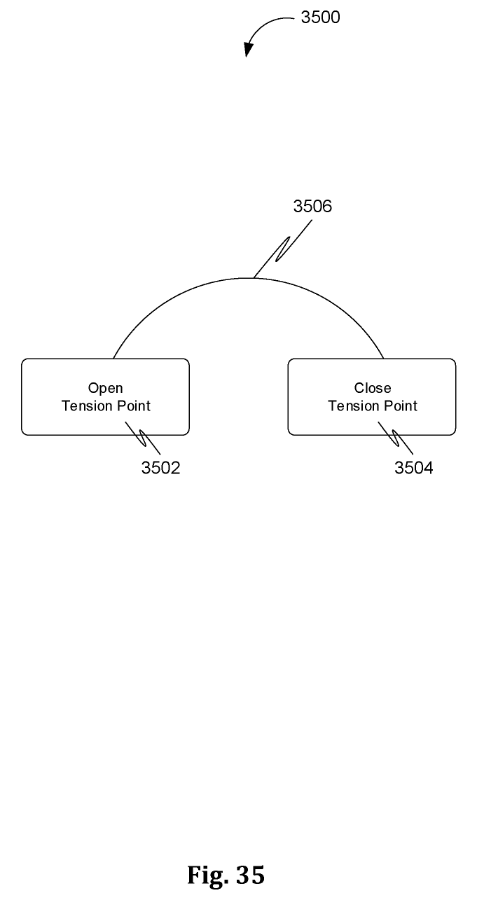

In the preferred embodiments, different tension sets may be implemented to illustrate the connections between the tension points of the story. As may be seen in FIG. 35 through 38, the tension sets may include, but are not limited to, open-close tension sets, open-continue-close tension sets, incomplete tension sets, and milieu bubble tension sets.

Further, the open-close tension set may be graphically displayed with two graphical cards connected by a curved line, and with the corresponding text shown on the graphical cards. Further, the open-continue-close tension set may include an open tension point, at least one continue tension point, and a close tension point, each displayed with a graphical card, and curved lines showing the connections of the open tension point and the at least one continue tension point to the close tension point. Further, several continue tension points may be implemented as necessary.

Further, the incomplete tension sets show how an aspect of the story might be set up or resolved. The graphical card of the corresponding tension point may be shown unconnected to other graphical cards. Further, milieu tension points may describe a unique aspect of the setting of the story. The milieu tension points may be displayed as a rectangular graphical card with a circle displayed above the graphical card. In other embodiments, different tension sets and graphical designs for the tension set may be implemented for the system.

As may be seen in FIG. 25 through 29, there may be no limit to how many tension points may be mapped across a single story or multiple episodes, seasons, chapters, installments of a story, or levels of a game. Each of the tension points may include one or more connections to other tension points according to the several clutches of the story that the tension point is involved in. The system may enable the viewing of the entire story or one or more selected tension sets. The process of displaying the tension points of at least one story may include the steps of prompting the user account to select the story display function with the user computing device. The software application’s GUI may display a story focus function that the user may select on the user computing device. Once the user may select the story focus function, all the tension points and the corresponding connections may be displayed on the display of the user computing device.

In the preferred embodiment, the graphical cards of the tension points corresponding to the story may be displayed in a linear arrangement in different patterns that allow the user to easily follow the story. The number and pattern of the tension points displayed depends on the display capabilities of the user computing device. For example, in a personal computer with a larger display, several tension points may be displayed in a linear chronological manner for the user to view.

As may be seen in FIG. 25 through 29, various viewing and navigation functions may be further implemented to help the user completely and clearly see all the tension points of the corresponding story. For example, depending on the display size of the user computing device, an appropriate amount of graphical cards may be displayed that allow the user to clearly see the description of each graphical card. A carousel design pattern may be implemented to facilitate the viewing of the story and the corresponding tension points. The amount of graphical cards displayed may be adjusted with a zooming feature that allows the user to increase/decrease the amount of the story displayed by the user computing device.

In addition, as the user navigates through the story, the user may “rotate” the carousel to display the consequent graphical cards. Transition effects may be implemented that allow the user to easily follow the chronology of the story. In other embodiments, additional functions may be implemented to help the user view the story and the corresponding tension points.

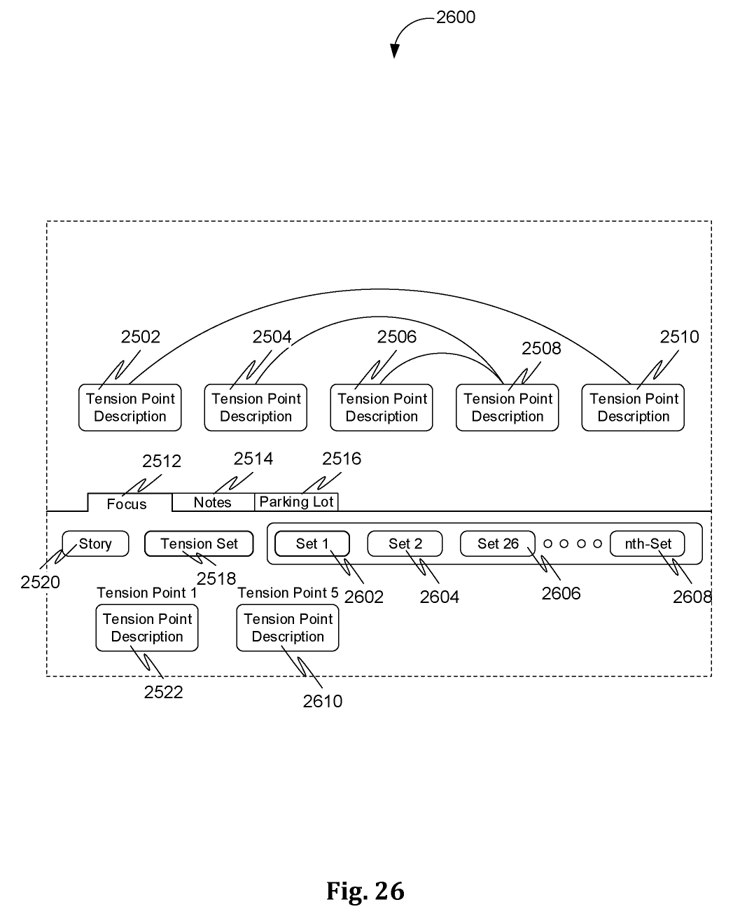

In addition, the software application’s GUI may also display a tension set focus function that the user may select on the user computing device. As may be seen in FIG. 26, once the user selects the tension set focus function, the tension points and the corresponding connections of a single tension set may be displayed on the display of the user computing device. In the preferred embodiment, the graphical cards of the tension points corresponding to the tension set may be displayed in a linear arrangement that allows the user to easily follow the connections of the tension set.

All the graphical cards corresponding to the tension points of the selected tension set may be displayed so that the user may clearly see all the connections involved in the tension set. Further, the software application’s GUI may display several set functions that allow the user to navigate through and navigate the different tension sets of the story. For example, several graphical cards may be displayed, each corresponding to a different tension set of the story. Different labels may be assigned to each tension set for easier navigation of the user while viewing the story. Furthermore, the selected tension set may also be graphically highlighted on the graphical cards illustrating the whole story. In other embodiments, different graphical means may be implemented to help the user track the tension sets being reviewed.

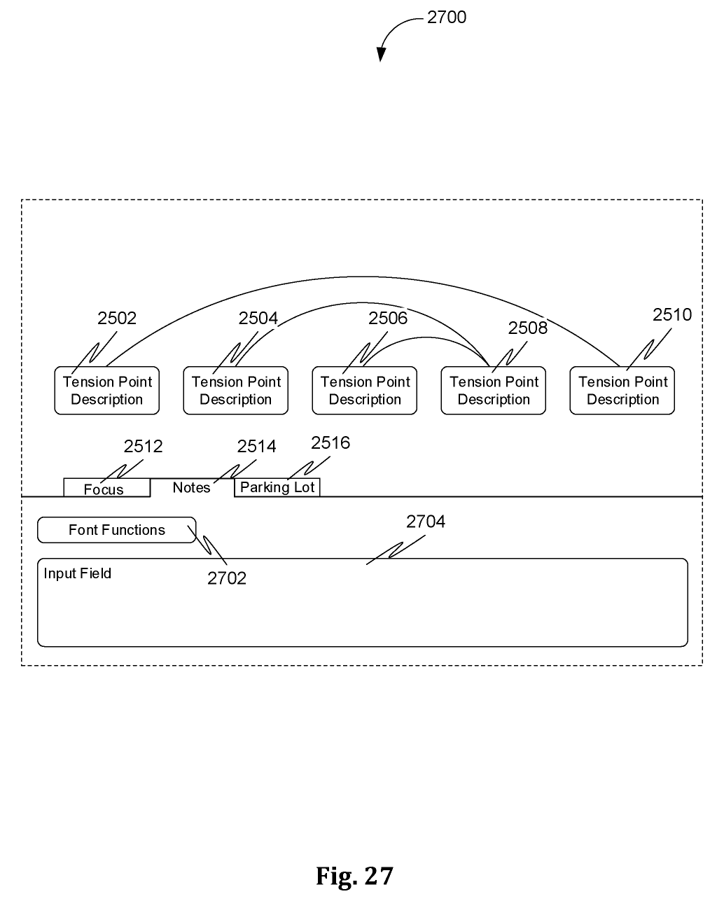

As may be seen in FIG. 27, to facilitate the monitoring of the story, the system may also provide means for the user to input and view a plurality of user notes that may be accessed while viewing the story. In the preferred embodiment, the software application’s GUI may further include a notes function provided along with the focus function that allows the user to easily access user notes to better understand the story, the tension points, and the corresponding connections. The notes function may allow the user to input the desired notes corresponding to the story, the tension sets, the tension points, the corresponding connections, etc.

Further, the process of entering user notes may include the steps of prompting the user account to enter user notes with the user computing device. The software application’s GUI may display at least one input field where the user may enter the desired user notes. The input field may include different input features that allow the user to properly input the desired notes. The input field preferably enables the input of user notes in text form. However, different formats may be implemented to help the user input the desired notes using different graphical elements with the user computing device.

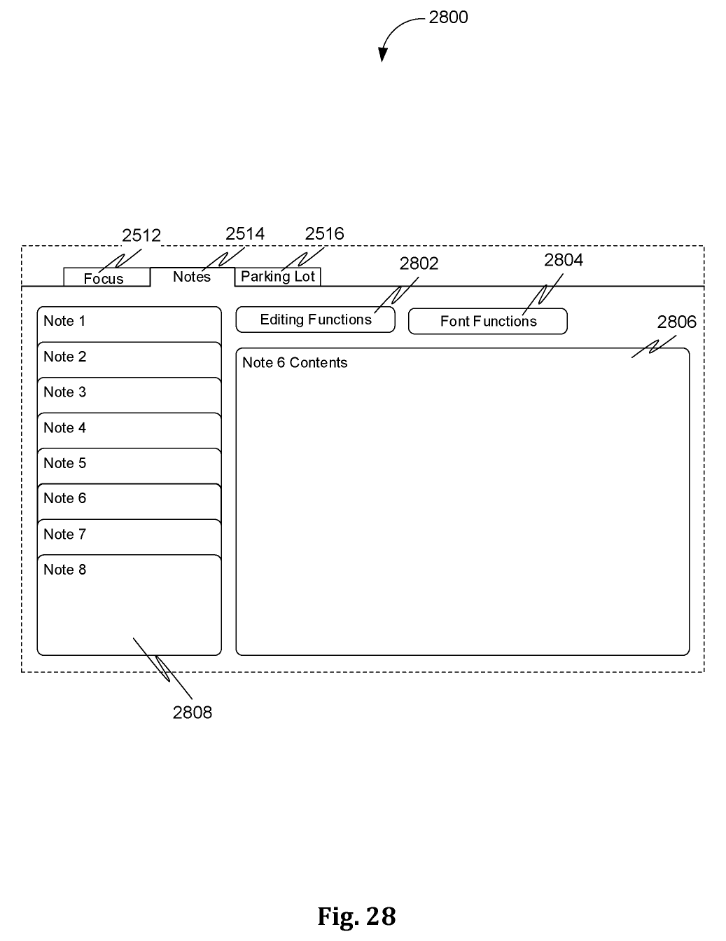

Once the user finishes the notes input, the user notes may be relayed from the user computing device to the remote server for storage. As may be seen in FIG. 28 , the notes function may display previous user notes as vertically stacked graphical cards that the user may browse through, so that the user may view the previous user notes. Further, the user account may be prompted to select at least one user note card with the user computing device to display the corresponding user notes. After the user selects a graphical card corresponding to previous user notes, the user computing device may display the corresponding user notes for the user to see. Several functions may be implemented to help the user organize, manipulate, and edit previous user notes. In other embodiments, different editorial features may be implemented to help the user track the story, the tension points, and the corresponding connections.

As may be seen in FIG. 25 through 29, in addition to the focus and note functions, the system may further include a parking lot function displayed on the software application’s GUI. In the preferred embodiment, the parking lot function may allow the storage of tension sets, user notes, other story elements, and story ideas that may be on hold. Similar to the notes function, the parking lot function may display “parked” notes and tension sets in a vertically stacked carousel of graphical cards that the user may browse through and select using the user computing device.

In general, the user account may be prompted to select a graphical card from the vertical stacked carousel with the user computing device. Once the user may select the desired graphical card, the user computing device may display the selected notes or tension set corresponding to the selected graphical card. Several browsing functions may be implemented to help the user see the parked notes and tension sets. In other embodiments, different functions may be implemented to help the user review the story and potential ideas.

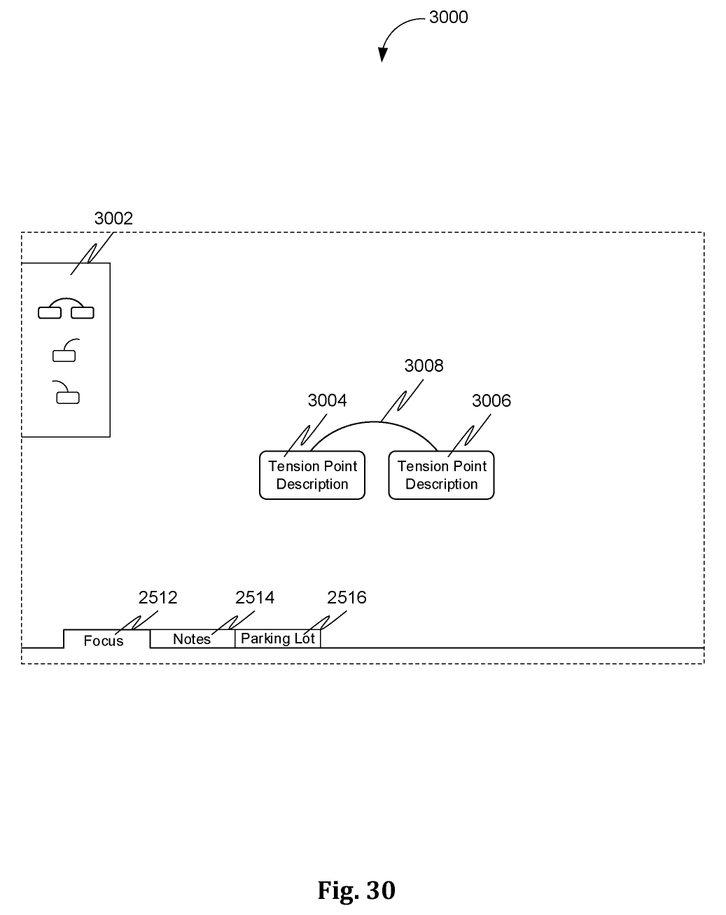

In some embodiments, the system allows the independent creation of tension sets without uploading a story file. As may be seen in FIG. 30 through 34, the system may further comprise a creator suite that allows the creation of tension sets from scratch. In the preferred embodiment, the creator suite may also be accessed via the software application with a plurality of creation functions that allow the user to manually create new tension sets. The creation functions include, but are not limited to, several functions that allow the creation of tension sets using preconfigured set templates that the user may utilize to input new tension points and form the connections that result in the creation of the desired tension sets.

Further, the process of creating new tension sets without an uploaded story file includes the steps of prompting the user to select at least one set template from the plurality of preconfigured set templates with the user computing device. The preconfigured set templates may be provided as a graphical toolbox from which the user may choose the desired set template. For example, using the input device of the user computing device, the user may click on the desired set template to automatically add the selected set template to the story. Each preconfigured set template may include one or more graphical cards to which the user may assign the desired tension points.

In addition, the preconfigured set templates may include predetermined connections depending on the number of graphical cards included in the preconfigured set template. For example, if the preconfigured set template may include two graphical cards, a connection may be already included to indicate the connection between the two graphical cards. The user may input as many predetermined sets as desired using the software application’s GUI.

As may be seen in FIG. 30 through 34, once the user has selected the desired predetermined set templates, the selected set templates may be displayed on the display of the user computing device. Then, the user account may be prompted to enter tension point information for each tension point on the corresponding selected set templates. The user computing device may display input fields on each graphical card of the selected set templates to facilitate the input of the necessary information for each tension set. Further, various editing functions may be implemented to help the user categorize and organize the new tension sets. Further, the user may add or edit new tension points for the new tension sets.

The process of adding new tension points on a tension set may include the steps of prompting the user to select a tension point from the tension set to which the new tension point is connected. For example, on a laptop or desktop computer, the user may right-click on a desired graphical card and select an “add a card to this set” function which results in a new graphical card being added that is connected to the selected graphical card. The user may select the desired tension point on the display of the user computing device and choose the option to add a new tension point. Further, the software application’s GUI may enable the editing of incomplete sets. For example, the user may right click on an incomplete set and select the “add an opening card to this set” function if the selected graphical card is a closing card or select the “add a closing card to this set” function if the selected graphical card is an opening card. In other embodiments, different editing functions may be implemented.

In addition, the software application’s GUI may enable the user to arrange the order of the graphical cards in relation to each other. As may be seen in FIG. 30 through 34, the process of rearranging the position of graphical cards includes the steps of prompting the user account to select the desired graphical card for rearrangement. For example, using the input device of the user computing device, the user may select the desired graphical card to be rearranged. The selected graphical card may then be dragged and dropped at the desired location for the graphical cards to be rearranged. Moreover, the user computing device graphically rearranges the selected graphical card according to the user input.

In other words, the selected graphical card may be moved according to the user input on the user computing device. The rearrangement may be aided using different graphical mechanisms that automatically rearrange the other graphical cards if necessary. For example, if the graphical cards may be initially displayed in close proximity to each other on the display of the user computing device, the user computing device may automatically move the adjacent graphical cards to provide space for the new position of the selected graphical card.

Additionally, the system may enable the movement of the created graphical sets and/or the graphical cards to the parking lot function. As may be seen in FIG. 30 through 34, the process of moving created graphical sets and/or graphical cards to the parking lot function may include the steps of prompting the user account to select at least one graphical card and/or graphical set with the user computing device. Once selected, the user account may be prompted to move the selected graphical card and/or graphical set to the parking lot function using the user computing device. For example, the user may right click on the desired graphical card and select the “move card to parking lot” function which results in the selected graphical being moved to the parking lot. In addition, a “move set to parking lot” may also be displayed that moves the entire selected tension set to the parking lot. The user computing device then graphically displays the selected graphical card and/or graphical set on the parking lot function. In other embodiments, different editorial features may be implemented to help the user create tension sets and stories without importing or uploading story files.

Additional functions may be implemented to help the user monitor and manage the story. In some embodiments, the system may further include an analytics dashboard on the software application for users to review quantitative and qualitative data on a given function set or group of groups of function sets. For example, the dashboard may display the number of tension sets, the number of types of tension sets or clutches used, data on incomplete tension sets, tension points per scene, chapter, episode, etc.

Furthermore, additional editorial functions may be implemented that help monitor the changes performed on the story by a user. For example, the user may edit the story during the markup process. In addition, every time a change is performed, an original version of the tension set and the story may be preserved so that edits may be made to the new version of the story. Further, when an edit to the tension points may be made throughout the editing process, the new metadata text is inserted into the original story. When tension points are deleted, the associated highlighted text in the story is struck through but not deleted. Similarly, when tension points are rearranged, the associated highlighted text in the story is reorganized to mirror the edited order. Thus, after subsequent versions of the story and tension sets are made, the user may compare the different versions on the software application using different graphical display methods, such as displaying the different versions side-to-side, stacked, etc.

Moreover, the system may enable the implementation of color-coding different aspects of the story being graphically represented by the tension points and tension sets. For example, the software application’s GUI may display different tension points and tension sets in different colors to aid the user when visualizing the story. The color-coding may be customizable and has no impact on the structure of the dataset. Similar to the previously discussed editing functions, the user may utilize the input device of the user computing device to right click on the desired graphical element (e.g., tension point, tension set, etc.), and select the desired color to be displayed for the selected graphical element. The different color options may be displayed on the selection menu for the user to choose from. Once selected, the chosen color for the graphical element may be displayed throughout the different functions, windows, or pages of the system’s software application. For example, when viewing the tension sets, the software application’s GUI displays each tension set and tension point with the corresponding color code. In addition, when viewing the tension set focus function, each tension set name tag is displayed with the corresponding color code. In other embodiments, different graphical marking methods may be implemented.

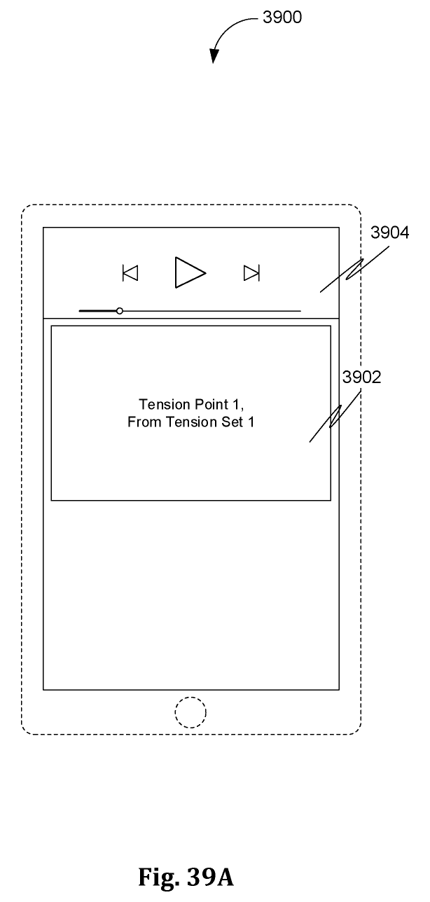

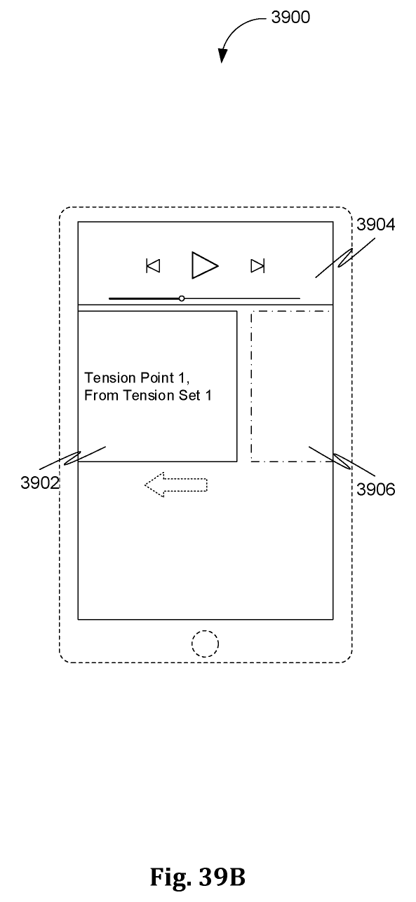

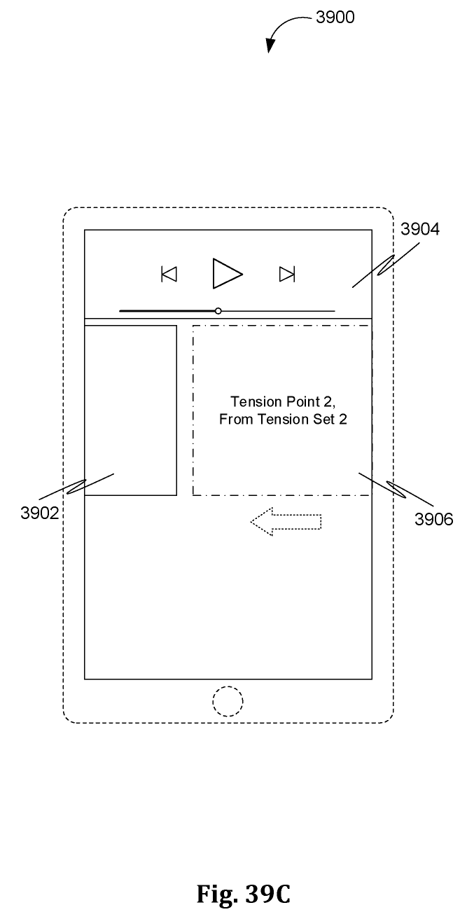

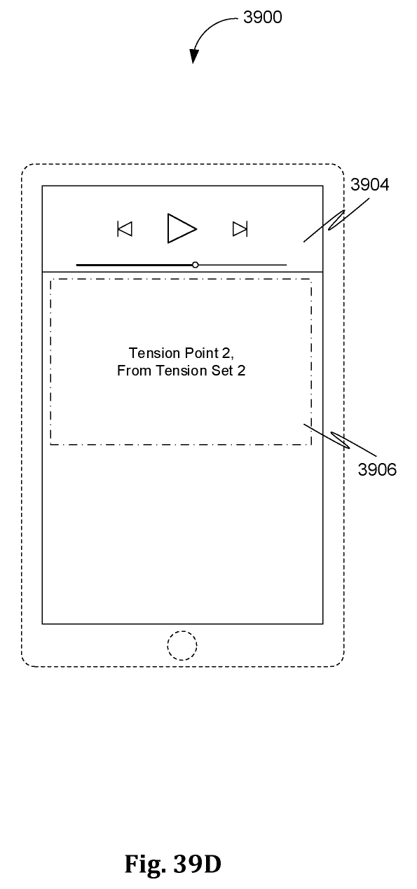

As previously discussed, the software application may be implemented in different versions that are compatible with different computing devices. As may be seen in FIG. 39 through 41, in one embodiment, the software application may be provided as a mobile application for a smartphone, tablet computer, or similar portable computing device. Due to the smaller display size, the software application displays the GUI and all graphical elements in a more compact manner. In the preferred embodiment, the mobile GUI includes a plurality of presentation functions that enable the user to view the entire story including all the tension sets and the corresponding tension points. The presentation functions include, but are not limited to, a play function, a rewind function, a forward function, a presentation status indicator, etc. The user computing device may display the presentation functions offset from the tension points that form the story as well as the corresponding tension sets.

In addition to the presentation functions, the mobile GUI of the software application preferably shows the corresponding tension points in a horizontal carousel in a chronological manner. As may be seen in FIG. 39 through 41, the horizontal carousel allows the user to view the tension points of the story in a chronological manner by “swiping” or rotating the horizontal carousel using the user interface of the user computing device. Further, to show the tension sets that involve the displayed tension points, the corresponding tension point of each tension set are displayed in a vertical arrangement right next to each other. For example, the tension points of the story may be displayed in a first horizontal carousel, and the connected tension points corresponding to the tension set are shown below.

Thus, as the “story” carousel may be rotated while watching the main story, the connected tension points of each tension set are displayed below the corresponding tension point. In line with the above method, the “story” carousel and the “set” carousel are displayed in a vertical stack arrangement for easy viewing. Further, the mobile version of the software application may allow users to enter user notes displayed in a compact manner on the mobile GUI. The user notes may be displayed below the corresponding tension points as the “story” carousel may be rotated for easy viewing of the story and the corresponding user notes. The mobile GUI may display the user notes in a vertical stack that may be rotated vertically to show all the user notes corresponding to the tension point currently displayed. In other embodiments, other editorial functions may be implemented to help the user better monitor the tension sets and the corresponding tension points of the story as the user views the story.

In other embodiments, the manual processes performed using the system may be automatically or semi-automatically performed using Artificial Intelligence (AI) or machine learning. For example, the user may upload a desired story, and the remote server may perform the uploading process automatically by ingesting the story and cross referencing the story with one or more libraries of definitions of tension types, or “clutches.” Further, the AI-powered system may generate a brief description, or metadata, to capture the text that may be populated on the graphical cards. Furthermore, different algorithms may be implemented to generate the rest of the dataset for a tension point based on logic. For example, the following logic may be implemented:

If a tension point is the first tension point in a tension set to occur in the story, the tension point may be designated as an “open” point.

If a tension point is the last tension point in a tension set to occur in the story, the tension point may be designated as a “close” point.

If a tension point is not the first tension point nor the last tension point in a tension set to occur in the story, the tension point may be designated as a “continuation” point.

In addition, the AI-powered system may provide edit suggestions during the different processes performed using the system. For example, AI-generated-edit suggestions may include, but are not limited to, the order of tension points within a tension set, the content on the graphical cards, the content in the original story, etc. Regardless of the AI-generated content, the user has full editorial access.

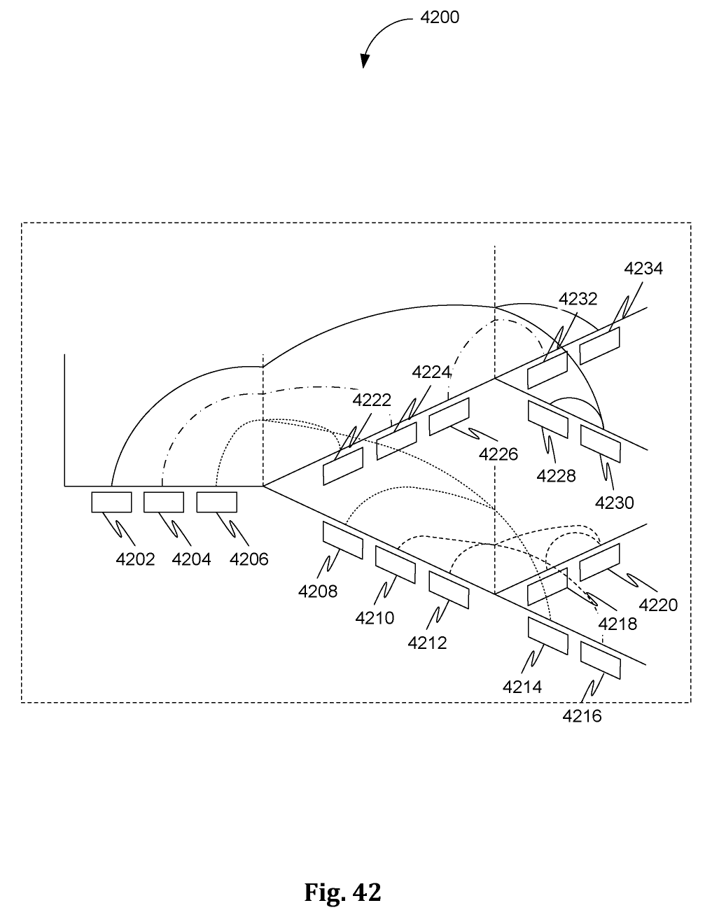

In other embodiments, the system may enable three-dimensional (3D) renderings of the story, the tension sets, and the corresponding tension points. The system may enable the display of a 3D model of branched narratives, such as choose-your-own-adventure type of stories, which are generally implemented in video games, interactive TV/web stories, etc. As may be seen in FIG. 42, in 3D branched narratives, the dataset of the story needs to include a few additional pieces of data for each tension point, as well as data regarding sections of the tension sets. The additional data may include, but is not limited to, inflection point identifiers, branch identifiers, endpoint identifiers, path identifiers, tier identifiers, etc. The inflection point identifiers may include a root inflection point that corresponds to the beginning of the story and other inflection points that correspond to any moments in a story or game in which the user decides which storyline or branch to follow. The branch identifier may correspond to a section of the story that takes place between inflection points. The endpoint identifiers may correspond to each possible end of a branched narrative which needs a unique identifier. The path identifiers may correspond to unique identifiers for each possible path for the user to follow, from the root to any endpoint. Further, the tier identifiers may correspond to the different branches formed throughout the story. For example, after the first branch in a story, each subsequent branch creates a new tier in the story. All branches directly following the first inflection point on a path are on the second tier, and the following branches are assigned to subsequent tiers.

Further, datasets for branched narratives may be generated in several ways depending on the system capabilities implemented. For example, the markup process may be manually performed with additional inputs for the additional data needed. If AI is implemented, the dataset may be automatically generated based on an existing text or existing data of video game user behavior, wherein the AI identifies tension points as defined in one or more tension point libraries. In addition, the dataset may be generated based on live input, from a video feed, footage, or video game user behavior.

In addition, the software application’s GUI may be altered to display the branched narratives in different manners. For example, the branched narratives may be displayed in a macro view wherein the entire story is displayed in a 3D model. In a focused view, one linear path from the branched narrative may be displayed at a time. Furthermore, the branched narratives version allows greater interactivity with the story. For example, users may flip through the branches and see variations of the story like flipping pages in a book.

As the user flips between different paths in the main tension map, the graphical cards may be automatically updated so the user may always easily follow the narrative. Further, users may edit the different elements of the branched narratives using the same processes of the linear two-dimensional (2D) version. Branched narrative creators may rearrange tension points, edit text/metadata on the graphical cards, delete tension points, use the parking lot function, duplicate branches, etc.

In alternate embodiments, the system and method may be altered to cater to specific applications, such as for education purposes. In the education version, educators may assign a text to students, and each student would manually create a tension set based on that text. The education version may be preferably able to accommodate several users simultaneously, and educators may perform many functions that facilitate the normal educational tasks performed in a school setting. For example, educators may create tension set assignments with due dates for students, review completed assignments by the students, individually or in aggregate, see data analytics on the student’s work, individually or in aggregate, grade the assignments, etc. Further, specific student functions may be implemented. For example, students may create tension sets in the manual method based on a text assigned by the teacher, compare tension sets to other tension sets, either from the public library or with classmates, see data analytics on the student’s work, individually or in aggregate, etc. In other embodiments, the present invention may be further customized for specific applications.

Further, the disclosed system and method may also be referred to as Loomanka, which discloses novel means of visualizing several literary devices, preferably the relationship between setups and payoffs throughout a story. To do so, the present disclosed describes an interactive system that may help the user to develop a tension map to track the relationship between setups and payoffs throughout a story. The tension map is a data graphical representation of the connections of setups and payoffs of a story that may be manually or automatically generated with the system. Further, the tension map may be displayed in different formats including, but not limited to, two-dimensional (2D) or three-dimensional (3D) formats that help the user visualize the different setups and payoffs throughout the corresponding story.

Further, the disclosed system and method may be implemented in the entertainment industry for different applications that cater to the needs of different users involved in one or more projects. For example, map makers such as screenwriters, writer’s assistants, and coverage writers may create tension maps based on a finished script or story, assess tension maps, or hand off a tension map to a different assessor. The assessor role may include, but is not limited to, a producer, director, financier, actor, agent, or other authorized users who need to decide to finance or otherwise participate in the project. In addition, creators and editors may be given access to explore the tension structure of a new idea before drafting a treatment or script on which to build a dataset.

Further, project collaborators who need clarity on the intent of the story and how the work may protect or uphold the creative vision may be given access to the corresponding tension map. Project collaborators may include, but are not limited to, other writers, producers, directors, storyboard artists, writer’s room staff, script supervisors, actors, editors, etc. Finally, in some embodiments, fans may be given access to the corresponding tension map to allow fans to enjoy reviews/recaps of the project to better understand what happened, or just to catch up. Other features may be implemented for different storytelling applications.

In some embodiments, the disclosed system inherently improves the functioning of graphical data visualization technologies by introducing a relationally linked data model that may encode narrative elements such as setups and payoffs as interconnected datasets. The technical problem addressed is that conventional story visualization systems are limited to static or non-relational representations that fail to express logical or temporal dependencies among narrative elements. The disclosed system may implement a relational dataset engine configured to define, store, and dynamically render nodes (e.g., tension points) and edges (e.g., clutches or narrative linkages) as data objects in a relational graph.

In some embodiments, the relational dataset engine may be implemented using graph databases (e.g., Neo4j or a proprietary relational data store), which may facilitate efficient retrieval and dynamic recomputation of narrative relationships during user manipulation. As a result, the disclosed system may improve the underlying data processing technology by enabling real-time structural transformation of a narrative’s logical graph while maintaining referential integrity.

In some embodiments, the disclosed system may further improve Graphical User Interface (GUI) rendering technology through adaptive visualization layers that may dynamically transform between two-dimensional (2D) and three-dimensional (3D) narrative representations. The technical problem addressed is that existing visualization systems may not fluidly morph between 2D and 3D views without requiring discrete re-rendering or user re-input. The disclosed rendering pipeline may use hierarchical scene graphs and GPU-accelerated transformations (e.g., via WebGL, Metal, or Vulkan) to dynamically extrude, fold, or collapse visual elements representing narrative paths. The above implementation may allow seamless continuity of user perception and eliminates re-rendering latency, thereby improving the rendering performance and perceptual consistency of interactive visualization systems.

In some embodiments, the disclosed system may improve natural language processing (NLP) systems through semi-automated story ingestion and tension classification. The technical problem addressed is that conventional text analysis systems lack specialized linguistic models for narrative “tension” and “clutch” recognition. The disclosed system may employ transformer-based NLP architectures (e.g., BERT, GPT, or fine-tuned T5 models) trained on annotated story corpora to detect semantic patterns corresponding to conflict, expectation, mystery, or risk phrases. The NLP subsystem may extract entities and classify tension types, automatically mapping them to graph nodes. The above implementation results in improved linguistic feature extraction accuracy for creative or narrative content—a specific improvement in NLP model specialization.

In some embodiments, the disclosed system may enhance collaborative cloud-based content management systems by introducing a multi-user relational state management protocol for synchronized editing of narrative visualizations. The technical problem addressed is that existing collaborative tools (e.g., Google Docs, Miro, Figma) are not optimized for object-relational editing across nested graph hierarchies. The disclosed system may employ operational transformation (OT) or conflict-free replicated data types (CRDTs) modified for graph-structured data, thereby ensuring consistency across multiple user sessions while allowing simultaneous modification of nodes, edges, and metadata. The disclosed system may further yield a technical improvement in real-time synchronization and consistency of relational datasets.

In some embodiments, the disclosed system may enhance data analytics and versioning technologies by integrating a multi-version concurrency control (MVCC) framework that preserves lineage among successive narrative graph states. The technical problem addressed is that conventional editing tools fail to maintain semantic integrity when graph objects are restructured. The disclosed system may implement a directed acyclic graph (DAG) of narrative revisions, each node storing deltas of graph metadata. This facilitates computational diffing, rollback, and side-by-side visualization of story evolution, thereby improving data versioning accuracy and analytical traceability.

In some embodiments, the disclosed system may also improve 3D modeling and simulation technologies by introducing tier-based narrative rendering engines that may represent branching narratives as hierarchical tiers with unique path identifiers. The technical problem addressed is the difficulty of maintaining coherent navigation across branching 3D narrative spaces. The system may employ matrix transformations and node-coordinate assignment algorithms to ensure spatial coherence between adjacent tiers. The improved rendering pipeline thus enables efficient hierarchical visualization of multi-path storylines, resulting in improved spatial computation and 3D narrative simulation performance.

In some embodiments, the system may further include reinforcement learning optimization for automated story-structure evaluation. The technical problem addressed is that manual validation of tension flow is subjective and time-consuming. The disclosed system may train a reinforcement agent that rewards narrative balance metrics (e.g., tension-to-resolution ratios). Such implementation improves AI-driven structural evaluation technologies.

In some embodiments, the system may employ predictive compression algorithms for storing narrative graphs. The technical problem addressed is excessive data redundancy in large multi-branch stories. The system may perform graph isomorphism detection and compress duplicate subgraphs, improving data storage efficiency and graph retrieval speed.

In some embodiments, the system may integrate context-aware visual accessibility engines that dynamically alter color palettes and layout density according to user cognitive load. The technical problem addressed is accessibility degradation in complex visualizations. The system may use eye-tracking or user-interaction analytics to automatically adjust rendering contrast and visual hierarchy, improving human-computer interaction (HCI) accessibility technologies.

In some embodiments, the disclosed system may implement temporal graph neural networks (TGNNs) to simulate story evolution over time. The technical problem addressed is the inability of static systems to predict how narrative tension evolves. The system may train TGNNs to forecast future tension patterns based on current graph state and user edits, thereby improving predictive modeling in narrative analytics.

In some embodiments, the system may include distributed rendering orchestration using edge-compute clusters to offload GPU-intensive 3D narrative visualization. The technical problem addressed is rendering latency on resource-constrained devices. The disclosed system may perform adaptive workload partitioning, where narrative rendering tasks are distributed to nearby edge nodes, improving distributed graphics rendering technologies.

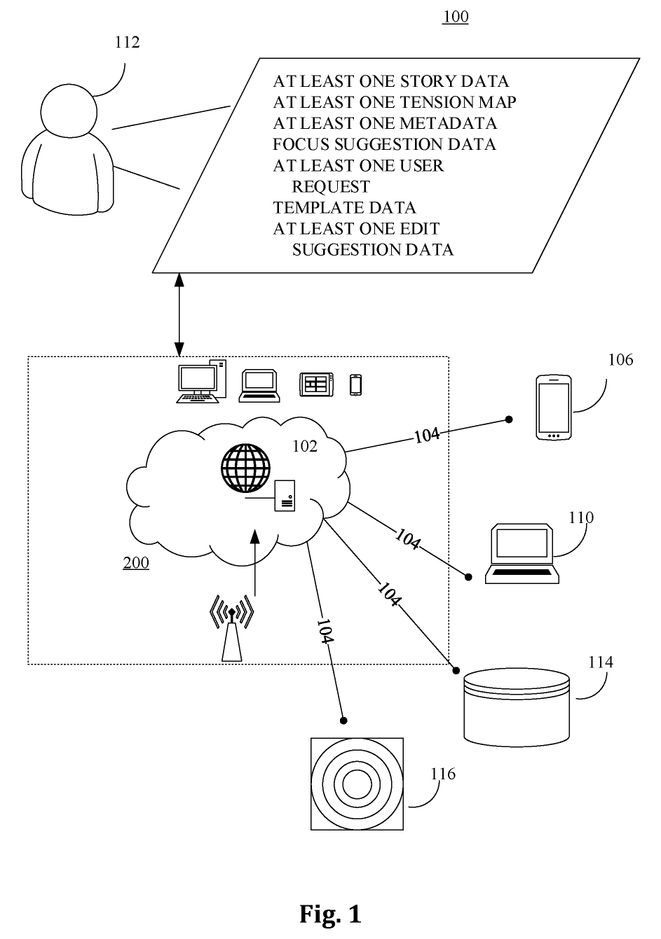

FIG. 1 is an illustration of an online platform 100 consistent with various embodiments of the present disclosure. By way of non-limiting example, the online platform 100 may be hosted on a centralized server 102, such as, for example, a cloud computing service. The centralized server 102 may communicate with other network entities, such as, for example, a mobile device 106 (such as a smartphone, a laptop, a tablet computer etc.), other electronic devices 110 (such as desktop computers, server computers etc.), databases 114, and sensors 116 over a communication network 104, such as, but not limited to, the Internet. Further, users of the online platform 100 may include relevant parties such as, but not limited to, end-users, administrators, service providers, service consumers and so on. Accordingly, in some instances, electronic devices operated by the one or more relevant parties may be in communication with the platform.

A user 112, such as the one or more relevant parties, may access online platform 100 through a web based software application or browser. The web based software application may be embodied as, for example, but not be limited to, a website, a web application, a desktop application, and a mobile application compatible with a computing device 200.

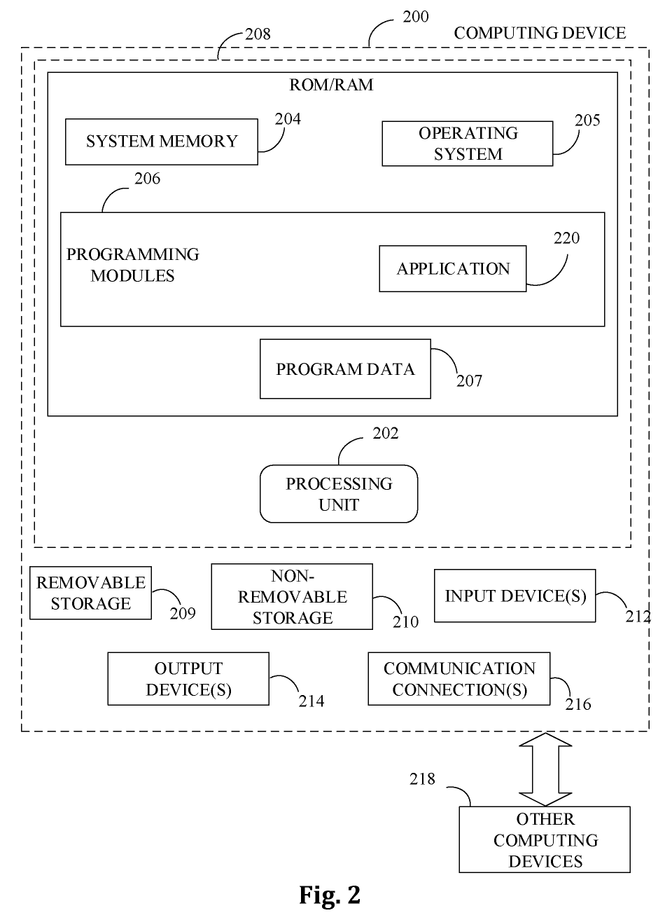

With reference to FIG. 2, a system consistent with an embodiment of the disclosure may include a computing device or cloud service, such as computing device 200. In a basic configuration, computing device 200 may include at least one processing unit 202 and a system memory 204. Depending on the configuration and type of computing device, system memory 204 may comprise, but is not limited to, volatile (e.g. random-access memory (RAM)), non-volatile (e.g. read-only memory (ROM)), flash memory, or any combination. System memory 204 may include operating system 205, one or more programming modules 206, and may include a program data 207. Operating system 205, for example, may be suitable for controlling computing device 200’s operation. In one embodiment, programming modules 206 may include image-processing module, machine learning module. Furthermore, embodiments of the disclosure may be practiced in conjunction with a graphics library, other operating systems, or any other application program and is not limited to any particular application or system. This basic configuration is illustrated in FIG. 2 by those components within a dashed line 208.

Computing device 200 may have additional features or functionality. For example, computing device 200 may also include additional data storage devices (removable and/or non-removable) such as, for example, magnetic disks, optical disks, or tape. Such additional storage is illustrated in FIG. 2 by a removable storage 209 and a non-removable storage 210. Computer storage media may include volatile and non-volatile, removable and non-removable media implemented in any method or technology for storage of information, such as computer-readable instructions, data structures, program modules, or other data. System memory 204, removable storage 209, and non-removable storage 210 are all computer storage media examples (i.e., memory storage.) Computer storage media may include, but is not limited to, RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other medium which can be used to store information and which can be accessed by computing device 200. Any such computer storage media may be part of device 200. Computing device 200 may also have input device(s) 212 such as a keyboard, a mouse, a pen, a sound input device, a touch input device, a location sensor, a camera, a biometric sensor, etc. Output device(s) 214 such as a display, speakers, a printer, etc. may also be included. The aforementioned devices are examples and others may be used.

Computing device 200 may also contain a communication connection 216 that may allow device 200 to communicate with other computing devices 218, such as over a network in a distributed computing environment, for example, an intranet or the Internet. Communication connection 216 is one example of communication media. Communication media may typically be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media. The term computer readable media as used herein may include both storage media and communication media.

As stated above, a number of program modules and data files may be stored in system memory 204, including operating system 205. While executing on processing unit 202, programming modules 206 (e.g., application 220 such as a media player) may perform processes including, for example, one or more stages of methods, algorithms, systems, applications, servers, databases as described above. The aforementioned process is an example, and processing unit 202 may perform other processes. Other programming modules that may be used in accordance with embodiments of the present disclosure may include machine learning applications.

Generally, consistent with embodiments of the disclosure, program modules may include routines, programs, components, data structures, and other types of structures that may perform particular tasks or that may implement particular abstract data types. Moreover, embodiments of the disclosure may be practiced with other computer system configurations, including hand-held devices, general purpose graphics processor-based systems, multiprocessor systems, microprocessor-based or programmable consumer electronics, application specific integrated circuit-based electronics, minicomputers, mainframe computers, and the like. Embodiments of the disclosure may also be practiced in distributed computing environments where tasks are performed by remote processing devices that are linked through a communications network. In a distributed computing environment, program modules may be located in both local and remote memory storage devices.

Furthermore, embodiments of the disclosure may be practiced in an electrical circuit comprising discrete electronic elements, packaged or integrated electronic chips containing logic gates, a circuit utilizing a microprocessor, or on a single chip containing electronic elements or microprocessors. Embodiments of the disclosure may also be practiced using other technologies capable of performing logical operations such as, for example, AND, OR, and NOT, including but not limited to mechanical, optical, fluidic, and quantum technologies. In addition, embodiments of the disclosure may be practiced within a general-purpose computer or in any other circuits or systems.

Embodiments of the disclosure, for example, may be implemented as a computer process (method), a computing system, or as an article of manufacture, such as a computer program product or computer readable media. The computer program product may be a computer storage media readable by a computer system and encoding a computer program of instructions for executing a computer process. The computer program product may also be a propagated signal on a carrier readable by a computing system and encoding a computer program of instructions for executing a computer process. Accordingly, the present disclosure may be embodied in hardware and/or in software (including firmware, resident software, micro-code, etc.). In other words, embodiments of the present disclosure may take the form of a computer program product on a computer-usable or computer-readable storage medium having computer-usable or computer-readable program code embodied in the medium for use by or in connection with an instruction execution system. A computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. More specific computer-readable medium examples (a non-exhaustive list), the computer-readable medium may include the following: an electrical connection having one or more wires, a portable computer diskette, a random-access memory (RAM), a read-only memory (ROM), an erasable programmable read-only memory (EPROM or Flash memory), an optical fiber, and a portable compact disc read-only memory (CD-ROM). Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

Embodiments of the present disclosure, for example, are described above with reference to block diagrams and/or operational illustrations of methods, systems, and computer program products according to embodiments of the disclosure. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

While certain embodiments of the disclosure have been described, other embodiments may exist. Furthermore, although embodiments of the present disclosure have been described as being associated with data stored in memory and other storage mediums, data can also be stored on or read from other types of computer-readable media, such as secondary storage devices, like hard disks, solid state storage (e.g., USB drive), or a CD-ROM, a carrier wave from the Internet, or other forms of RAM or ROM. Further, the disclosed methods’ stages may be modified in any manner, including by reordering stages and/or inserting or deleting stages, without departing from the disclosure.

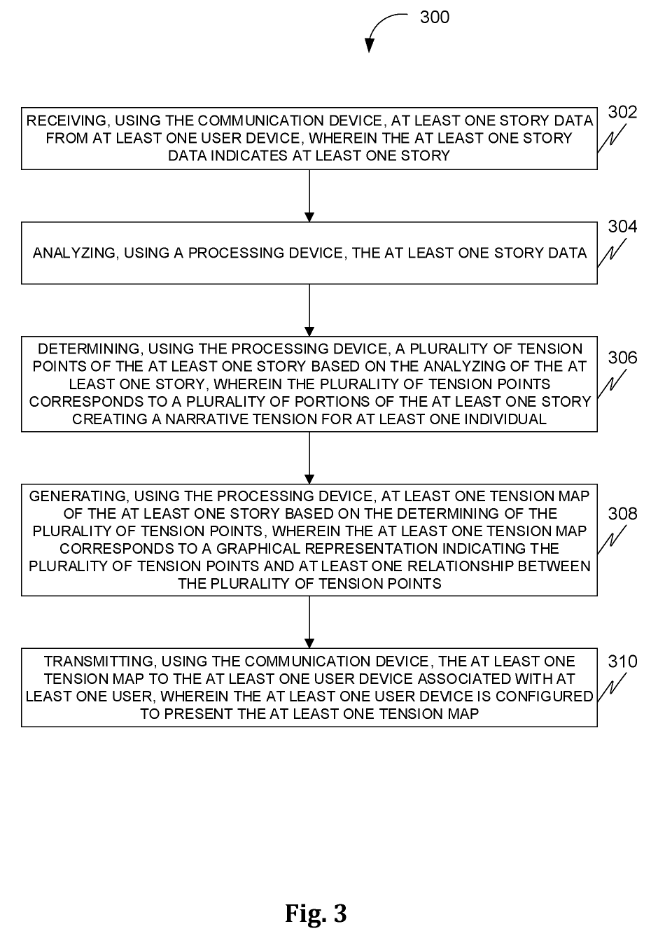

FIG. 3 illustrates a flowchart of a method 300 of facilitating generation of data representing patterns in narrative media, in accordance with some embodiments. Further, the method 300 may include a step 302 of receiving, using the communication device 902, one or more story data from one or more user devices. Further, the one or more story data indicates one or more stories. Further, the method 300 may include a step 304 of analyzing, using a processing device 904, the one or more story data. Further, the method 300 may include a step 306 of determining, using the processing device 904, two or more tension points of the one or more stories based on the analyzing of the one or more stories. Further, the two or more tension points correspond to two or more portions of the one or more stories creating a narrative tension for one or more individuals. Further, the method 300 may include a step 308 of generating, using the processing device 904, one or more tension maps of the one or more stories based on the determining of the two or more tension points. Further, the one or more tension maps correspond to a graphical representation indicating the two or more tension points and one or more relationships between the two or more tension points. Further, the method 300 may include a step 310 of transmitting, using the communication device 902, the one or more tension maps to the one or more user devices associated with one or more users. Further, the one or more user devices may be configured to present the one or more tension maps.

In some embodiments, the one or more users comprise one or more of one or more creators and one or more audience.

In some embodiments, the one or more individuals comprise one or more audiences.

In some embodiments, the one or more stories comprise an infinite content.

In some embodiments, the one or more users comprise one or more readers of the one or more stories.

In some embodiments, the one or more stories correspond to the narrative media.

In some embodiments, the one or more stories correspond to one or more television series.

In some embodiments, each of the two or more tension points corresponds to one of an individual setup and an individual payoff of the one or more stories.

In some embodiments, the one or more tensions correspond to the graphical representation of two or more setups and two or more payoffs of the one or more stories.

In some embodiments, the analyzing of the one or more story data includes analyzing the one or more story data using an Artificial Intelligence (AI) model. Further, the AI model may be configured to analyze one or more story data based on two or more predefined tension data. Further, the two or more predefined tension data correspond to definitions of two or more tension types. Further, the determining of the two or more tension points may be based on the analyzing of the one or more story data using the AI model.

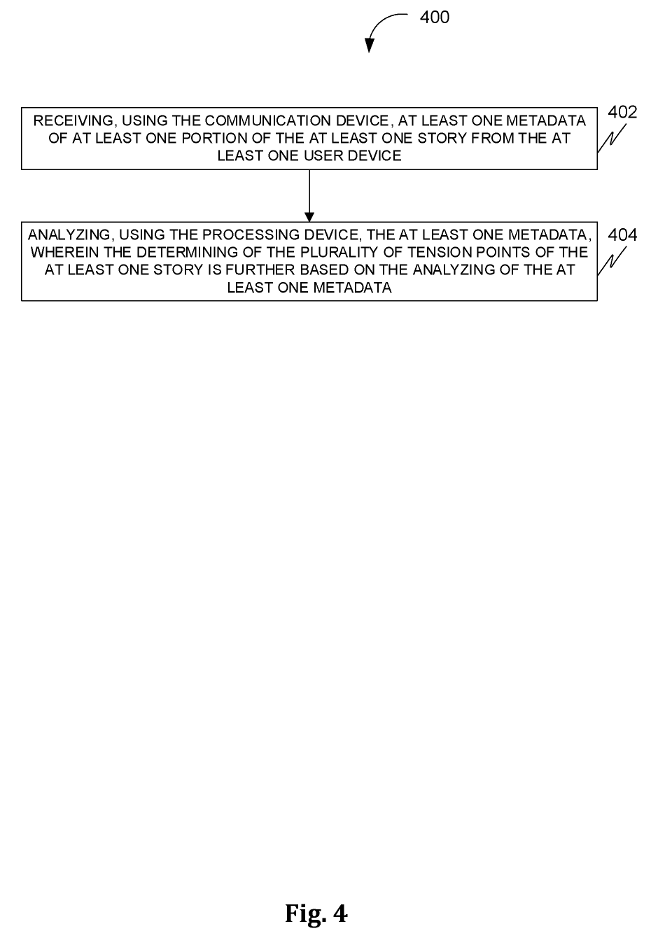

FIG. 4 illustrates a flowchart of a method 400 of facilitating generation of data representing patterns in narrative media including analyzing, using the processing device 904, the at least one metadata, in accordance with some embodiments. Further, in some embodiments, the method 400 further may include a step 402 of receiving, using the communication device 902, one or more metadata of one or more portions of the one or more stories from the one or more user devices. Further, in some embodiments, the method 400 further may include a step 404 of analyzing, using the processing device 904, the one or more metadata. Further, the determining of the two or more tension points of the one or more stories may be further based on the analyzing of the one or more metadata.

In some embodiments, the one or more tension maps include two or more graphical cards representing the two or more tension points. Further, the one or more tension maps further include one or more lines connecting the two or more graphical cards. Further, the one or more lines indicate the one or more relationships between the two or more tension points.

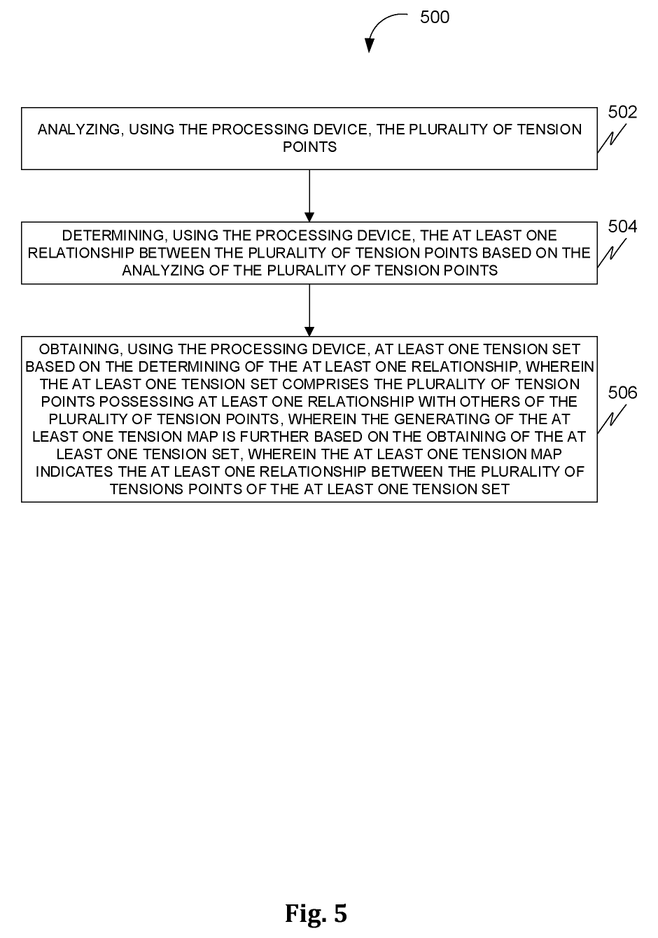

FIG. 5 illustrates a flowchart of a method 500 of facilitating generation of data representing patterns in narrative media including obtaining, using the processing device 904, at least one tension set, in accordance with some embodiments. Further, in some embodiments, the method 500 further may include a step 502 of analyzing, using the processing device 904, the two or more tension points. Further, in some embodiments, the method 500 further may include a step 504 of determining, using the processing device 904, the one or more relationships between the two or more tension points based on the analyzing of the two or more tension points. Further, in some embodiments, the method 500 further may include obtaining, using the processing device 904, one or more tension sets based on the determining of the one or more relationships. Further, the one or more tension sets include the two or more tension points possessing one or more relationships with others of the two or more tension points. Further, the generating of the one or more tension maps may be further based on the obtaining of the one or more tension sets. Further, the one or more tension maps indicate the one or more relationships between the two or more tension points of the one or more tension sets.

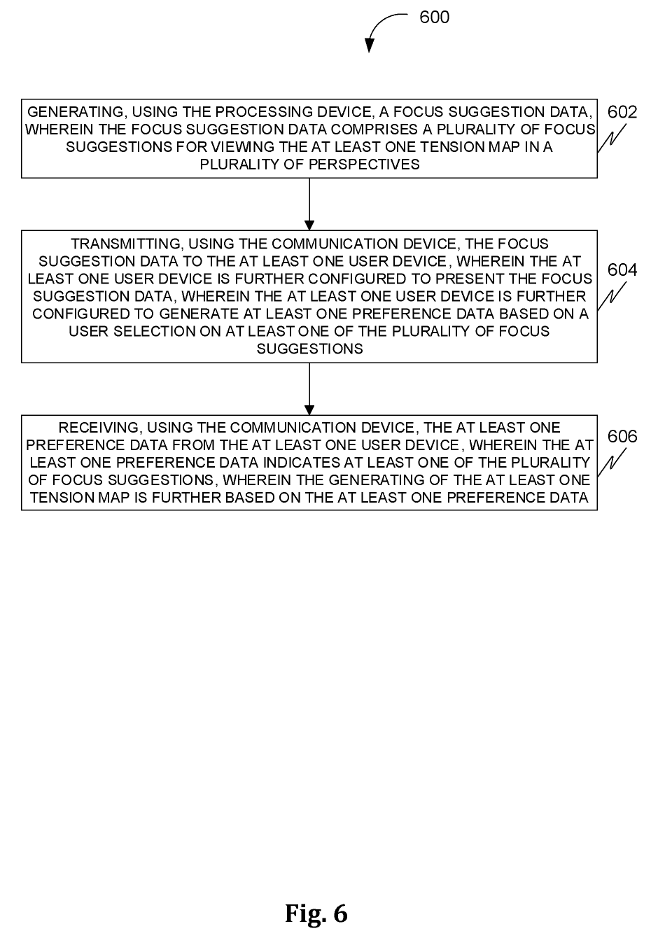

FIG. 6 illustrates a flowchart of a method 600 of facilitating generation of data representing patterns in narrative media including receiving, using the communication device 902, the at least one preference data from the at least one user device, in accordance with some embodiments. Further, in some embodiments, the method 600 further may include a step 602 of generating, using the processing device 904, a focus suggestion data. Further, the focus suggestion data includes two or more focus suggestions for viewing the one or more tension maps in two or more perspectives. Further, in some embodiments, the method 600 further may include a step 604 of transmitting, using the communication device 902, the focus suggestion data to the one or more user devices. Further, the one or more user devices may be further configured to present the focus suggestion data. Further, the one or more user devices may be further configured to generate one or more preference data based on a user selection on one or more of the two or more focus suggestions. Further, in some embodiments, the method 600 further may include a step 606 of receiving, using the communication device 902, the one or more preference data from the one or more user devices. Further, the one or more preference data indicate one or more of the two or more focus suggestions. Further, the generating of the one or more tension maps may be further based on the one or more preference data.

In some embodiments, the two or more focus suggestions include a story focus suggestion and a tension set focus suggestion. Further, the one or more preference data indicate the story focus suggestion. Further, the one or more tension maps represent the two or more tension points of the one or more stories and the one or more relationships between the two or more tension points.

In some embodiments, the two or more focus suggestions include a story focus suggestion and a tension set focus suggestion. Further, the one or more preference data indicate the tension set focus suggestion. Further, the one or more tension maps represent the two or more tension points of one or more tension sets of the one or more stories and the one or more relationships between the two or more tension points.

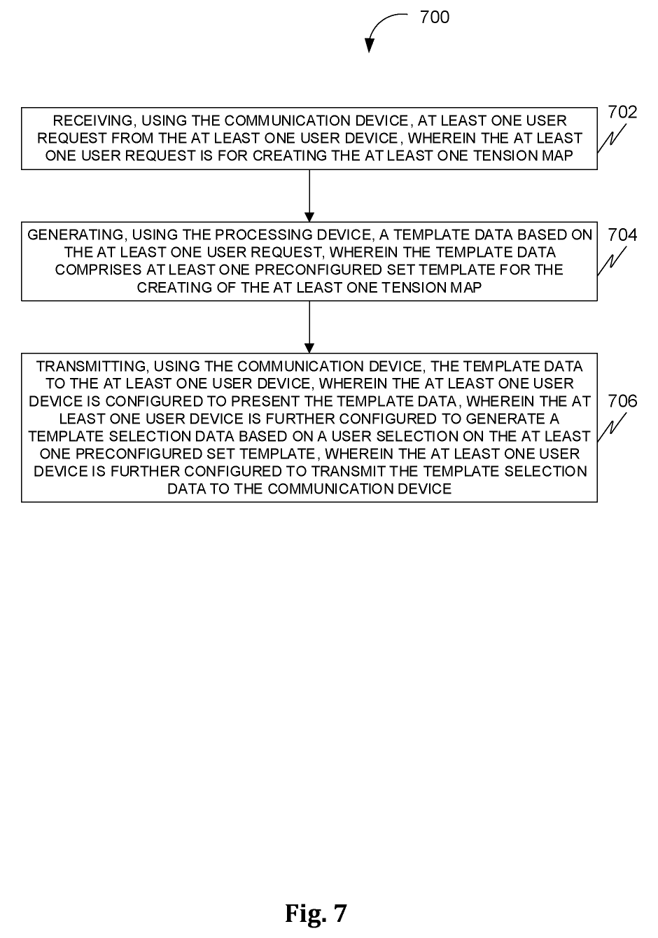

FIG. 7 illustrates a flowchart of a method 700 of facilitating generation of data representing patterns in narrative media including generating, using the processing device 904, a template data, in accordance with some embodiments. Further, in some embodiments, the method 700 further may include a step 702 of receiving, using the communication device 902, one or more user requests from the one or more user devices. Further, the one or more user requests may be for creation of the one or more tension maps. Further, in some embodiments, the method 700 further may include a step 704 of generating, using the processing device 904, a template data based on the one or more user requests. Further, the template data includes one or more preconfigured set templates for the creation of the one or more tension maps. Further, in some embodiments, the method 700 further may include a step 706 of transmitting, using the communication device 902, the template data to the one or more user devices. Further, the one or more user devices may be configured to present the template data. Further, the one or more user devices may be further configured to generate a template selection data based on a user selection on the one or more preconfigured set templates. Further, the one or more user devices may be further configured to transmit the template selection data to the communication device 902.

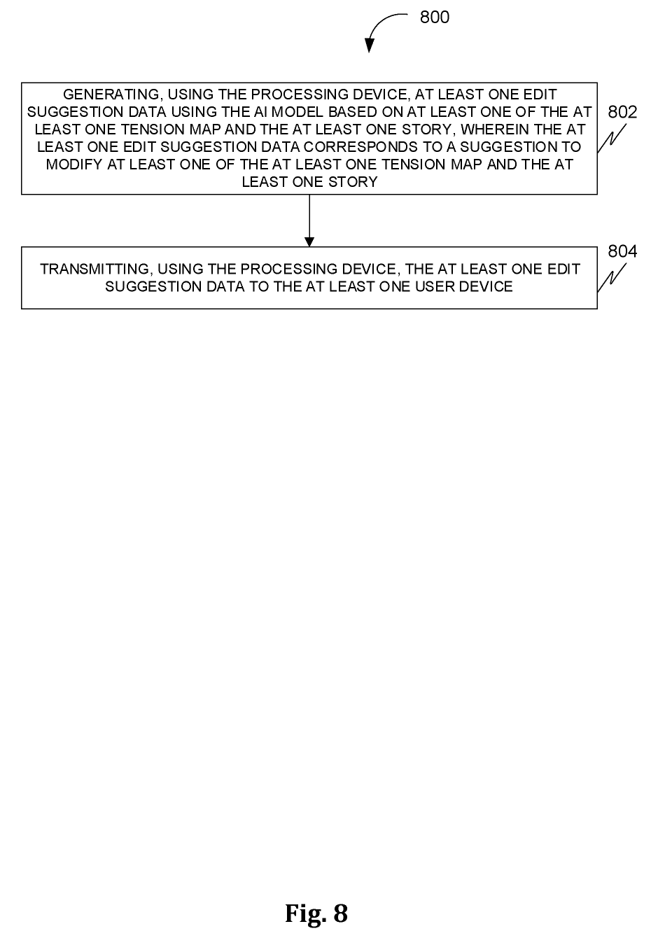

FIG. 8 illustrates a flowchart of a method 800 of facilitating generation of data representing patterns in narrative media including generating, using the processing device 904, at least one edit suggestion data using the AI model, in accordance with some embodiments. Further, in some embodiments, the method 800 further may include a step 802 of generating, using the processing device 904, one or more edit suggestion data using the AI model based on one or more of the one or more tension maps and the one or more stories. Further, the one or more edit suggestion data corresponds to a suggestion to modify one or more of the one or more tension maps and the one or more stories. Further, in some embodiments, the method 800 further may include a step 804 of transmitting, using the processing device 904, the one or more edit suggestion data to the one or more user devices.

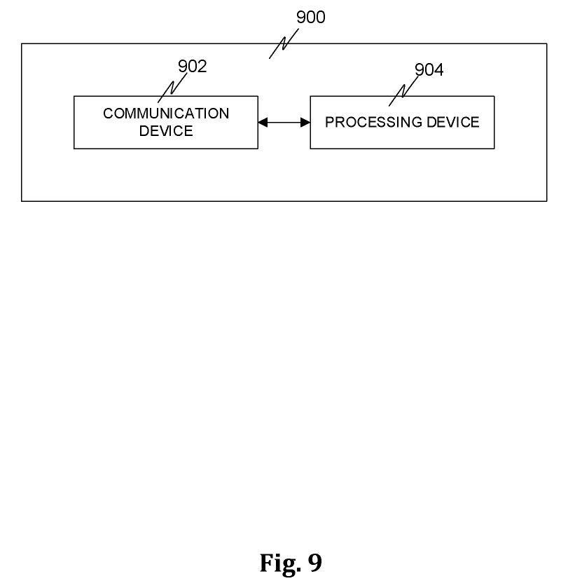

FIG. 9 illustrates a block diagram of a system 900 of facilitating generation of data representing patterns in narrative media, in accordance with some embodiments. Further, the system 900 may include a communication device 902. Further, the communication device 902 may be configured for receiving one or more story data from one or more user devices. Further, the one or more story data indicate one or more stories. Further, the communication device 902 may be configured for transmitting one or more tension maps to the one or more user devices associated with one or more users. Further, the one or more user devices may be configured to present the one or more tension maps. Further, the system 900 may include a processing device 904 communicatively coupled with the communication device 902. Further, the processing device 904 may be configured for analyzing the one or more story data. Further, the processing device 904 may be configured for determining two or more tension points of the one or more stories based on the analyzing of the one or more stories. Further, the two or more tension points correspond to two or more portions of the one or more stories creating a narrative tension for one or more individuals. Further, the processing device 904 may be configured for generating the one or more tension maps of the one or more stories based on the determining of the two or more tension points. Further, the one or more tension maps correspond to a graphical representation indicating the two or more tension points and one or more relationships between the two or more tension points.

In some embodiments, the analyzing of the one or more story data includes analyzing the one or more story data using an Artificial Intelligence (AI) model. Further, the AI model may be configured to analyze the one or more story data based on two or more predefined tension data. Further, the two or more predefined tension data correspond to definitions of two or more tension types. Further, the determining of the two or more tension points may be based on the analyzing of the one or more story data using the AI model.

In some embodiments, the communication device 902 may be further configured for receiving one or more metadata of one or more portions of the one or more stories from the one or more user devices. Further, the processing device 904 may be further configured for analyzing the one or more metadata. Further, the determining of the two or more tension points of the one or more stories may be further based on the analyzing of the one or more metadata.

In some embodiments, the one or more tension maps include two or more graphical cards representing the two or more tension points. Further, the one or more tension maps further include one or more lines connecting the two or more graphical cards. Further, the one or more lines indicate the one or more relationships between the two or more tension points.

Further, in some embodiments, the processing device 904 may be further configured for analyzing the two or more tension points. Further, the processing device 904 may be further configured for determining the one or more relationships between the two or more tension points based on the analyzing of the two or more tension points. Further, the processing device 904 may be further configured for obtaining one or more tension sets based on the determining of the one or more relationships. Further, the one or more tension sets include the two or more tension points possessing the one or more relationships with others of the two or more tension points. Further, the generating of the one or more tension maps may be further based on the obtaining of the one or more tension sets. Further, the one or more tension maps indicate the one or more relationships between the two or more tension points of the one or more tension sets.

Further, in some embodiments, the processing device 904 may be further configured for generating a focus suggestion data. Further, the focus suggestion data may include two or more focus suggestions for viewing the one or more tension maps in two or more perspectives. Further, the communication device 902 may be further configured for transmitting the focus suggestion data to the one or more user devices. Further, the one or more user devices may be further configured to present the focus suggestion data. Further, the one or more user devices may be further configured to generate one or more preference data based on a user selection on one or more of the two or more focus suggestions. Further, the processing device 904 may be further configured for generating a focus suggestion data. Further, the communication device 902 may be further configured for receiving the one or more preference data from the one or more user devices. Further, the one or more preference data indicate one or more of the two or more focus suggestions. Further, the generating of the one or more tension maps may be further based on the one or more preference data.

In some embodiments, the two or more focus suggestions include a story focus suggestion and a tension set focus suggestion. Further, the one or more preference data indicates the story focus suggestion. Further, the one or more tension maps represent the two or more tension points of the one or more stories and the one or more relationships between the two or more tension points.

In some embodiments, the two or more focus suggestions include a story focus suggestion and a tension set focus suggestion. Further, the one or more preference data indicate the tension set focus suggestion. Further, the one or more tension maps represent the two or more tension points of one or more tension sets of the one or more stories and the one or more relationships between the two or more tension points.

Further, in some embodiments, the communication device 902 may be further configured for receiving one or more user requests from the one or more user devices. Further, the one or more user requests may be for creating the one or more tension maps. Further, the communication device 902 may be further configured for transmitting a template data to the one or more user devices. Further, the one or more user devices may be configured to present the template data. Further, the one or more user devices may be further configured to generate a template selection data based on a user selection on one or more preconfigured set templates. Further, the one or more user devices may be further configured to transmit the template selection data to the communication device 902. Further, the processing device 904 may be further configured for generating the template data based on the one or more user requests. Further, the template data includes the one or more preconfigured set templates for the creating of the one or more tension maps.

In some embodiments, the processing device 904 may be further configured for generating one or more edit suggestion data using the AI model based on one or more of the one or more tension maps and the one or more stories. Further, the one or more edit suggestion data correspond to a suggestion to modify one or more of the one or more tension maps and the one or more stories. Further, the communication device 902 may be further configured for transmitting the one or more edit suggestion data to the one or more user devices.

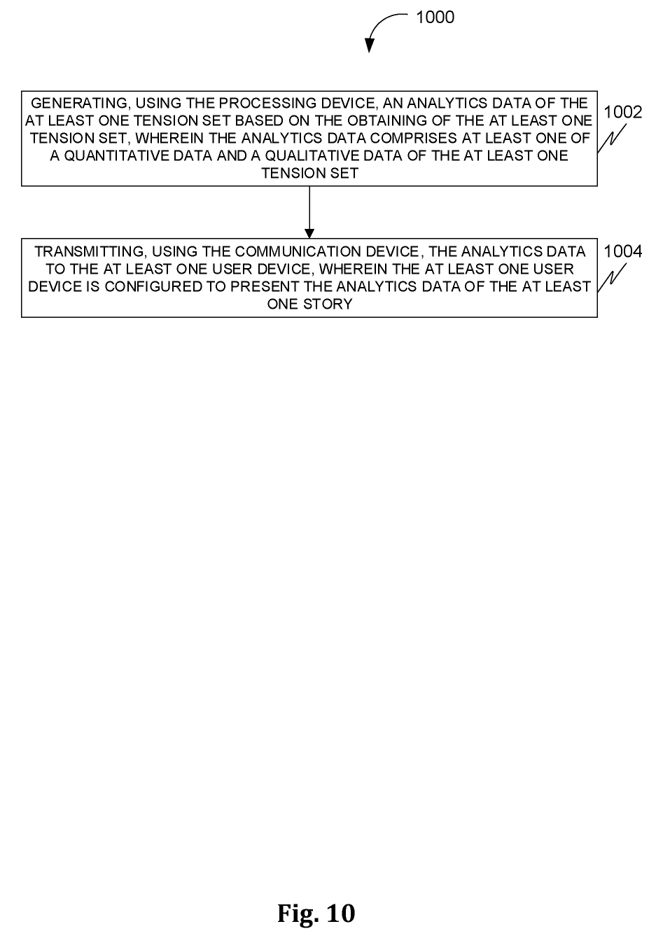

FIG. 10 illustrates a flowchart of a method 1000 of facilitating generation of tension maps including generating, using the processing device 904, an analytics data of the at least one tension set, in accordance with some embodiments. Further, in some embodiments, the method 1000 further may include a step 1002 of generating, using the processing device 904, an analytics data of the one or more tension sets based on the obtaining of the one or more tension sets. Further, the analytics data includes one or more of a quantitative data and a qualitative data of the one or more tension sets. Further, in some embodiments, the method 1000 further may include a step 1004 of transmitting, using the communication device 902, the analytics data to the one or more user devices. Further, the one or more user devices may be configured to present the analytics data of the one or more stories.

In some embodiments, the generating of the one or more tension maps includes generating one or more descriptions of each of the two or more tension points using one or more logic-based algorithms. Further, the one or more logic-based algorithms use one or more logics to classify the two or more tension points. Further, the one or more descriptions indicate a classification of the two or more tension points.

In some embodiments, the one or more user devices may be configured to execute a software application. Further, the one or more user devices may be further configured to transmit the one or more story data to the communication device 902 based on the executing of the software application. Further, the software application includes an upload module which may be configured to facilitate the transmitting of the one or more story data.

In some embodiments, the executing of the software application includes processing one or more native story data to obtain the one or more story data. Further, the one or more native story data may be characterized by a first file format and the one or more story data may be characterized by a second file format. Further, the second file format may be different from the first file format. Further, the transmitting of the one or more story data may be based on the processing of the one or more native story data.

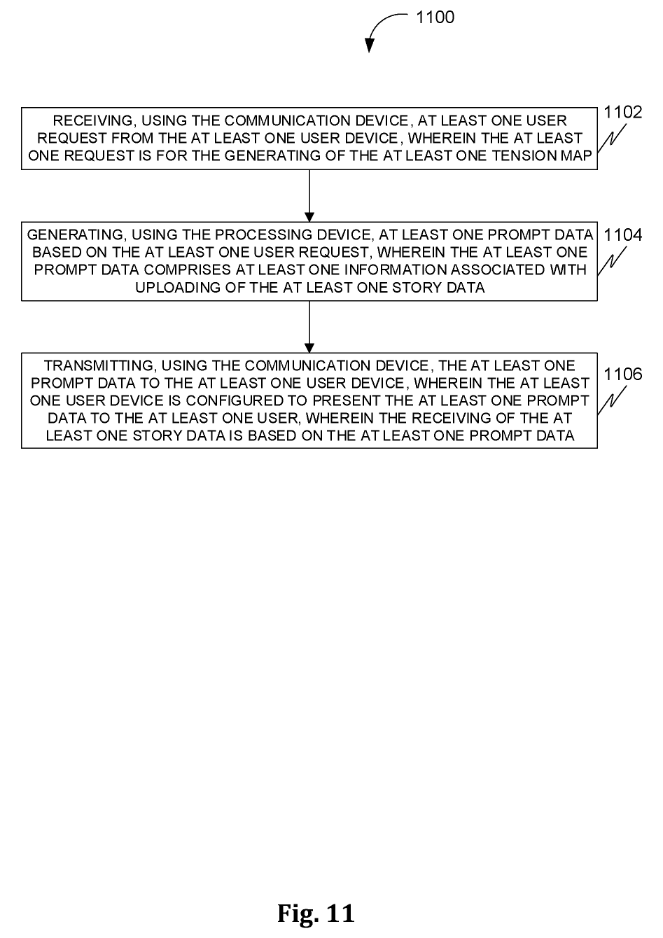

FIG. 11 illustrates a flowchart of a method 1100 of facilitating generation of data representing patterns in narrative media including generating, using the processing device 904, at least one prompt data, in accordance with some embodiments. Further, in some embodiments, the method 1100 further may include a step 1102 of receiving, using the communication device 902, one or more user requests from the one or more user devices. Further, the one or more requests may be for the generating of the one or more tension maps. Further, in some embodiments, the method 1100 further may include a step 1104 of generating, using the processing device 904, one or more prompt data based on the one or more user requests. Further, the one or more prompt data includes one or more information associated with uploading of the one or more story data. Further, in some embodiments, the method 1100 further may include a step 1106 of transmitting, using the communication device 902, the one or more prompt data to the one or more user devices. Further, the one or more user devices may be configured to present the one or more prompt data to the one or more users. Further, the receiving of the one or more story data may be based on the one or more prompt data.

In some embodiments, the method 400 may further include transmitting, using the communication device 902, the one or more story data to the one or more user devices. Further, the one or more user devices may be configured to present the one or more story data. Further, the one or more user devices may be further configured to generate the one or more metadata based on one or more user interactions with the one or more story data. Further, the one or more user devices may be further configured to transmit the one or more metadata to the communication device 902.

In some embodiments, the one or more story data includes two or more texts indicating the one or more stories. Further, the one or more user interactions include one or more of selecting one or more texts from the two or more texts and entering one or more additional information for the one or more texts.

In some embodiments, the one or more metadata of the one or more portions indicate one or more of a tension type of the one or more portions, a description of one or more tensions associated with the one or more portions, a clutch type of the one or more tensions, and a label of one or more tensions set associated with the one or more portions.

In some embodiments, the method 400 may further include generating, using the processing device 904, one or more mapping functions associated with the generating of the one or more tension maps. Further, the transmitting of the one or more story data may be based on the generating of the one or more mapping functions. Further, the transmitting of the one or more story data includes transmitting the one or more story data with the one or more mapping functions. Further, the presenting of the one or more story data includes presenting the one or more story data with the one or more mapping functions.

In some embodiments, the executing of the software application includes executing the software application to allow the one or more users to manipulate the one or more story data. Further, the transmitting of the one or more story data may be based on the executing of the software application to allow the one or more users to manipulate the one or more story data.

In some embodiments, the graphical representation includes one or more of a two-dimensional representation (2D) of the one or more relationships and a three-dimensional representation (3D) of the one or more relationships.

In some embodiments, the two or more tension points indicate a setup of the one or more stories and a payoff of the one or more stories.

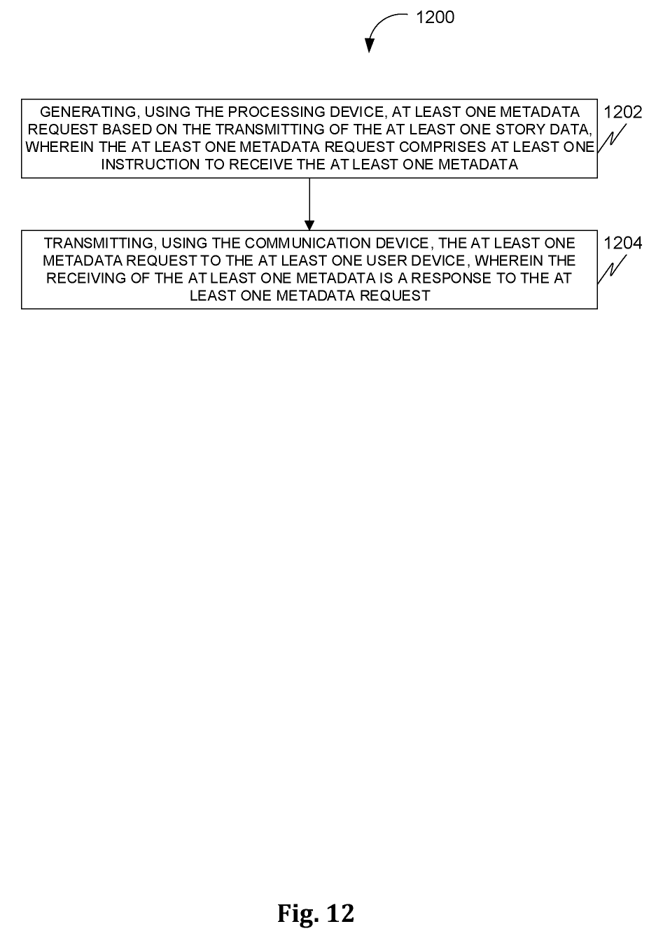

FIG. 12 illustrates a flowchart of a method 1200 of facilitating generation of data representing patterns in narrative media including generating, using the processing device 904, at least one metadata request, in accordance with some embodiments. Further, in some embodiments, the method 1200 further may include a step 1202 of generating, using the processing device 904, one or more metadata requests based on the transmitting of the one or more story data. Further, the one or more metadata requests include one or more instructions to receive the one or more metadata. Further, in some embodiments, the method 1200 further may include a step 1204 of transmitting, using the communication device 902, the one or more metadata requests to the one or more user devices. Further, the receiving of the one or more metadata may be a response to the one or more metadata requests.

In some embodiments, the one or more lines include a solid line.

In some embodiments, the two or more graphical cards may be characterized by a rectangular shape and one or more rounded corners.

In some embodiments, the one or more tension sets include one or more of one or more open-close tension sets, one or more open-continue-close tension sets, one or more incomplete tension sets, and a milieu bubble tension set.

In some embodiments, the one or more open-close tension sets include the two or more tension points comprising a first tension point and a second tension point. Further, the one or more tension maps include a first graphical card representing the first tension point and a second graphical card representing the second tension point. Further, the first tension point corresponds to an open tension point and the second tension point corresponds to a close tension point. Further, the one or more tension maps include a line connecting the first graphical card and the second graphical card to represent the one or more relationships between the first tension point and the second tension point.

In some embodiments, the one or more open-continue-close tension sets include the two or more tension points comprising a first tension point, a second tension point, and a third tension point. Further, the one or more tension maps include a first graphical card representing the first tension point, a second graphical card representing the second tension point, and a third graphical card representing the third tension point. Further, the first tension point corresponds to an open tension point, the second tension point corresponds to a continue-tension point, and the third tension point corresponds to a close tension point. Further, the one or more tension maps include two or more lines connecting the first graphical card and the second graphical card to the third graphical card to represent the one or more relationships between the two or more tension points.

In some embodiments, the one or more incomplete tension sets include one or more incomplete tension points. Further, the one or more tension maps include one or more graphical cards representing the one or more incomplete tension points. Further, the one or more tension maps further include one or more lines. Further, a first end of the one or more lines may be connected to the one or more graphical cards. Further, the second end of the one or more lines may be unconnected. Further, the one or more tension maps of the one or more incomplete tension sets indicate an incompleteness of the one or more incomplete tension points in the one or more stories.

In some embodiments, the milieu bubble tension set includes one or more milieu tension points representing a unique aspect of the one or more stories. Further, the one or more tension maps include one or more graphical cards and one or more circles. Further, the one or more circles may be positioned above the one or more graphical cards representing the one or more milieu tension points.

In some embodiments, the one or more tension maps further include one or more descriptions on each of the two or more graphical cards.

In some embodiments, the presenting of the one or more tension maps includes presenting the two or more graphical cards in a linear arrangement. Further, the one or more stories may include a linear story. Further, the one or more user devices may be configured to allow the one or more users to navigate through the linear story by sliding between the two or more graphical cards of the two or more tension points.

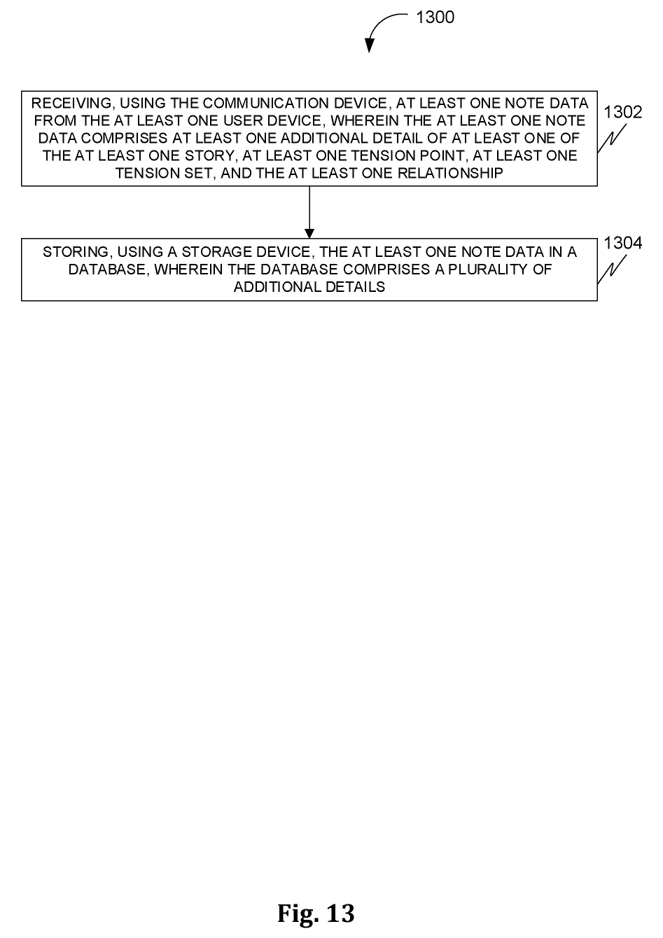

FIG. 13 illustrates a flowchart of a method 1300 of facilitating generation of data representing patterns in narrative media including receiving, using the communication device 902, at least one note data from the at least one user device, in accordance with some embodiments. Further, in some embodiments, the method 1300 further may include a step 1302 of receiving, using the communication device 902, one or more note data from the one or more user devices. Further, the one or more note data includes one or more additional details of one or more of the one or more stories, one or more tension points, one or more tension sets, and the one or more relationships. Further, in some embodiments, the method 1300 further may include a step 1304 of storing, using a storage device, the one or more note data in a database. Further, the database includes two or more additional details.

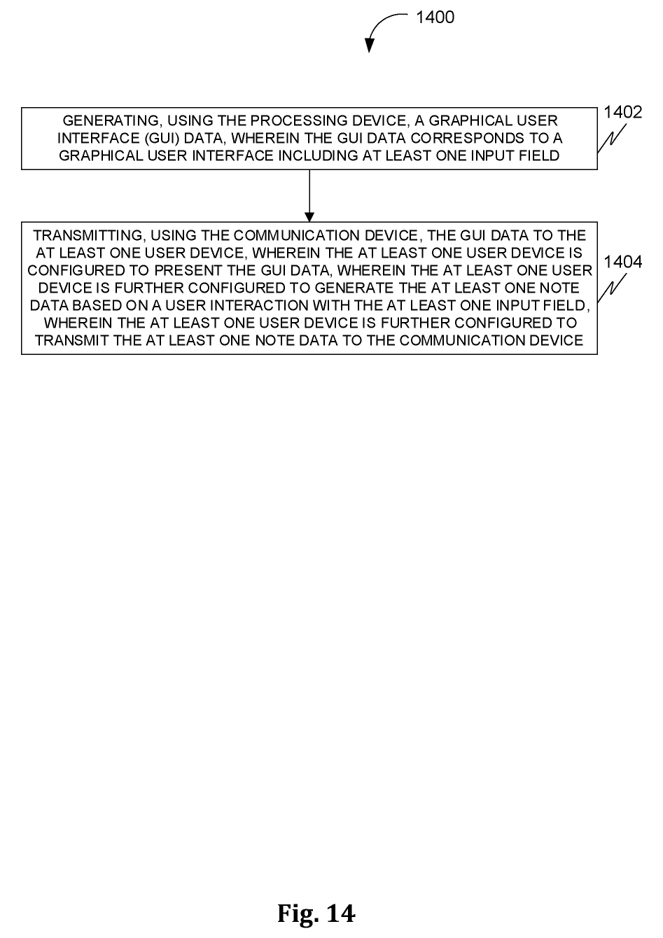

FIG. 14 illustrates a flowchart of a method 1400 of facilitating generation of data representing patterns in narrative media including generating, using the processing device 904, a Graphical User Interface (GUI) data, in accordance with some embodiments. Further, in some embodiments, the method 1400 further may include a step 1402 of generating, using the processing device 904, a Graphical User Interface (GUI) data. Further, the GUI data corresponds to a Graphical User Interface including one or more input fields. Further, in some embodiments, the method 1400 further may include a step 1404 of transmitting, using the communication device 902, the GUI data to the one or more user devices. Further, the one or more user devices may be configured to present the GUI data. Further, the one or more user devices may be further configured to generate the one or more note data based on a user interaction with the one or more input fields. Further, the one or more user devices may be further configured to transmit the one or more note data to the communication device 902.

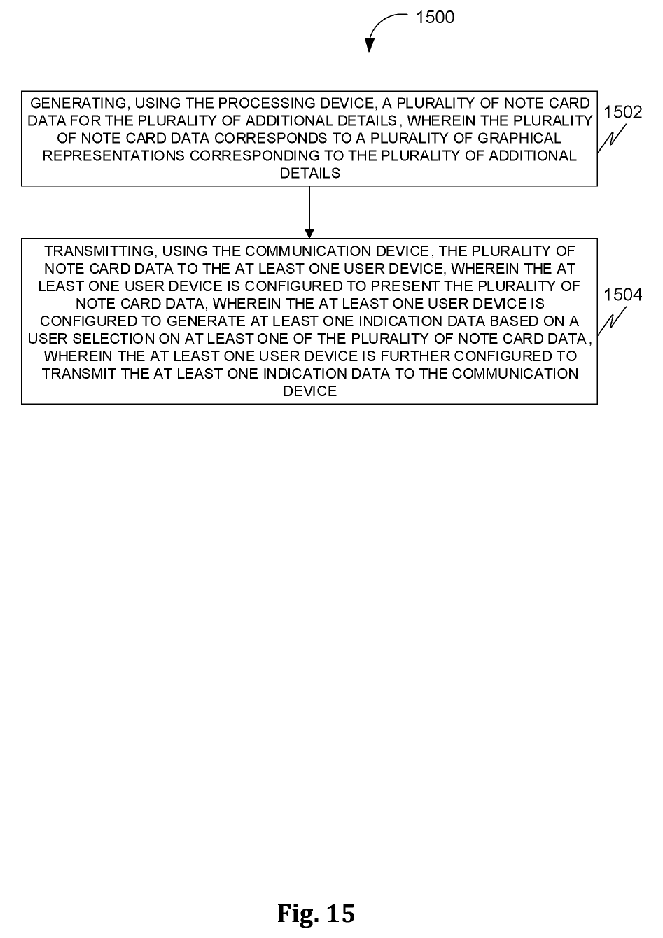

FIG. 15 illustrates a flowchart of a method 1500 of facilitating generation of tension maps including generating, using the processing device 904, a plurality of note card data for the plurality of additional details, in accordance with some embodiments. Further, in some embodiments, the method 1500 further may include a step 1502 of generating, using the processing device 904, two or more note card data for the two or more additional details. Further, the two or more note card data corresponds to two or more graphical representations corresponding to the two or more additional details. Further, in some embodiments, the method 1500 further may include a step 1504 of transmitting, using the communication device 902, the two or more note card data to the one or more user devices. Further, the one or more user devices may be configured to present the two or more note card data. Further, the one or more user devices may be configured to generate one or more indication data based on a user selection on one or more of the two or more note card data. Further, the one or more user devices may be further configured to transmit the one or more indication data to the communication device 902.

In some embodiments, the presenting of the two or more note card data includes presenting two or more note cards in a vertical arrangement.

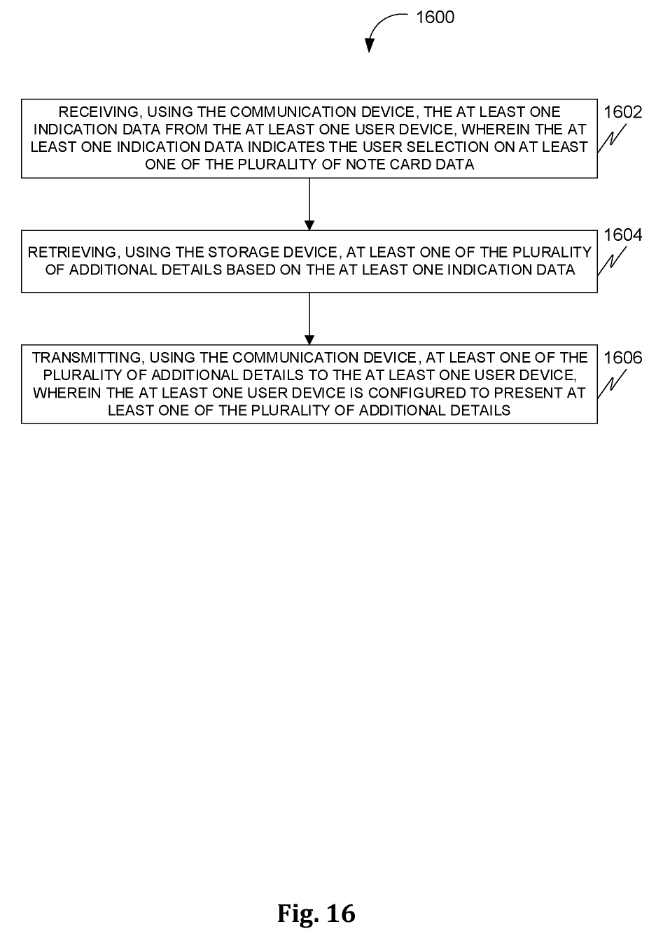

FIG. 16 illustrates a flowchart of a method 1600 of facilitating generation of data representing patterns in narrative media including retrieving, using the storage device, at least one of the plurality of additional details, in accordance with some embodiments. Further, in some embodiments, the method 1600 further may include a step 1602 of receiving, using the communication device 902, the one or more indication data from the one or more user devices. Further, the one or more indication data indicate the user selection on one or more of the two or more note card data. Further, in some embodiments, the method 1600 further may include a step 1604 of retrieving, using the storage device, one or more of the two or more additional details based on the one or more indication data. Further, in some embodiments, the method 1600 further may include a step 1606 of transmitting, using the communication device 902, one or more of the two or more additional details to the one or more user devices. Further, the one or more user devices may be configured to present one or more of the two or more additional details.

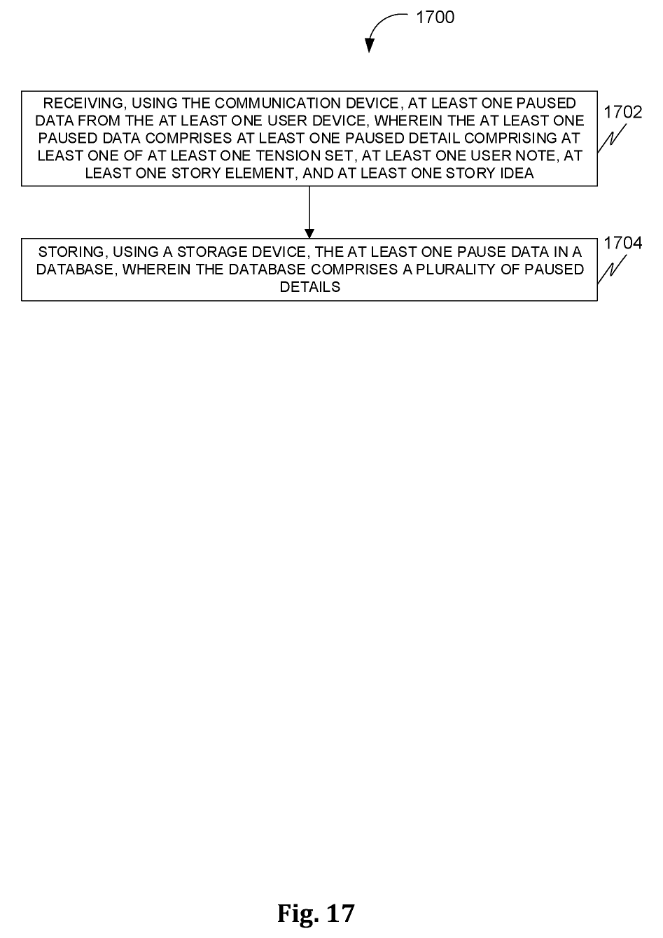

FIG. 17 illustrates a flowchart of a method 1700 of facilitating generation of data representing patterns in narrative media including receiving, using the communication device 902, at least one paused data from the at least one user device, in accordance with some embodiments. Further, in some embodiments, the method 1700 further may include a step 1702 of receiving, using the communication device 902, one or more paused data from the one or more user devices. Further, the one or more paused data includes one or more paused details comprising one or more of one or more tension sets, one or more user notes, one or more story elements, and one or more story ideas. Further, in some embodiments, the method 1700 further may include a step 1704 of storing, using a storage device, the one or more pause data in a database. Further, the database includes two or more paused details.

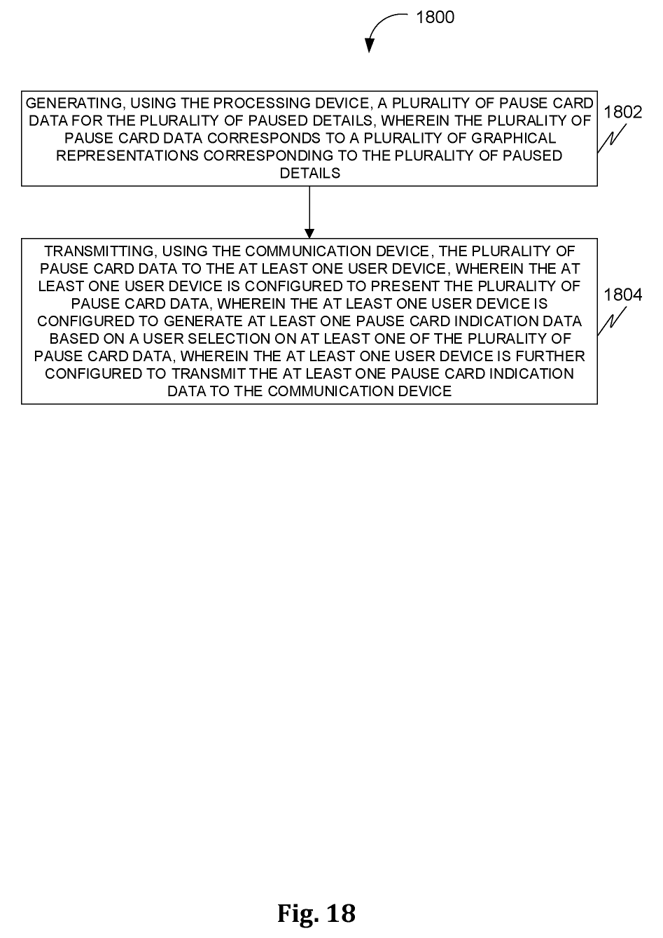

FIG. 18 illustrates a flowchart of a method 1800 of facilitating generation of data representing patterns in narrative media including generating, using the processing device 904, a plurality of pause card data for the plurality of paused details, in accordance with some embodiments. Further, in some embodiments, the method 1800 further may include a step 1802 of generating, using the processing device 904, two or more pause card data for the two or more paused details. Further, the two or more pause card data correspond to two or more graphical representations corresponding to the two or more paused details. Further, in some embodiments, the method 1800 further may include a step 1804 of transmitting, using the communication device 902, the two or more pause card data to the one or more user devices. Further, the one or more user devices may be configured to present the two or more pause card data. Further, the one or more user devices may be configured to generate one or more pause card indication data based on a user selection on one or more of the two or more pause card data. Further, the one or more user devices may be further configured to transmit the one or more pause card indication data to the communication device 902.

In some embodiments, the presenting of the two or more pause card data includes presenting two or more pause cards in a vertical arrangement.

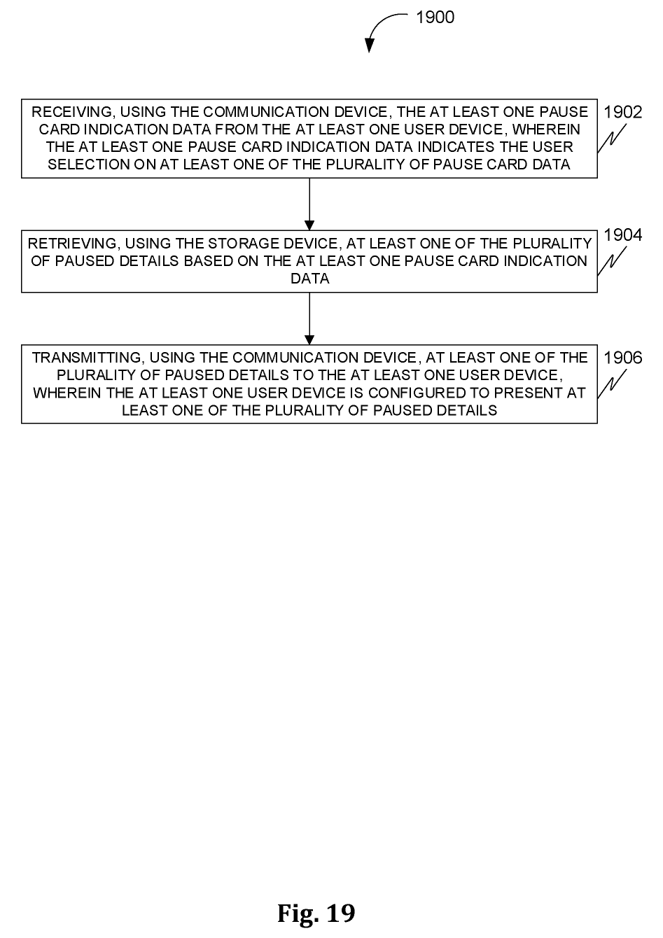

FIG. 19 illustrates a flowchart of a method 1900 of facilitating generation of data representing patterns in narrative media including retrieving, using the storage device, at least one of the plurality of paused details, in accordance with some embodiments. Further, in some embodiments, the method 1900 further may include a step 1902 of receiving, using the communication device 902, the one or more pause card indication data from the one or more user devices. Further, the one or more pause card indication data indicates the user selection on one or more of the two or more pause card data. Further, in some embodiments, the method 1900 further may include a step 1904 of retrieving, using the storage device, one or more of the two or more paused details based on the one or more pause card indication data. Further, in some embodiments, the method 1900 further may include a step 1906 of transmitting, using the communication device 902, one or more of the two or more paused details to the one or more user devices. Further, the one or more user devices may be configured to present one or more of the two or more paused details.

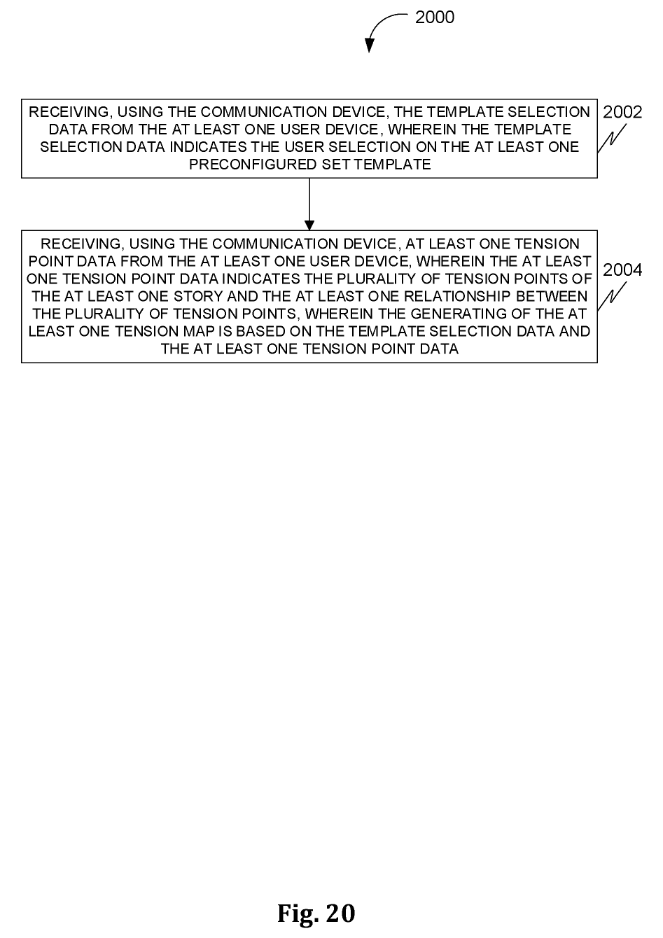

FIG. 20 illustrates a flowchart of a method 2000 of facilitating generation of data representing patterns in narrative media including receiving, using the communication device 902, at least one tension point data from the at least one user device, in accordance with some embodiments. Further, in some embodiments, the method 2000 further may include a step 2002 of receiving, using the communication device 902, the template selection data from the one or more user devices. Further, the template selection data indicates the user selection on the one or more preconfigured set templates. Further, in some embodiments, the method 2000 further may include a step 2004 of receiving, using the communication device 902, one or more tension point data from the one or more user devices. Further, the one or more tension point data indicate the two or more tension points of the one or more stories and the one or more relationships between the two or more tension points. Further, the generating of the one or more tension maps may be based on the template selection data and the one or more tension point data.

In some embodiments, the one or more preconfigured set templates include one or more graphical cards and one or more predetermined connections.

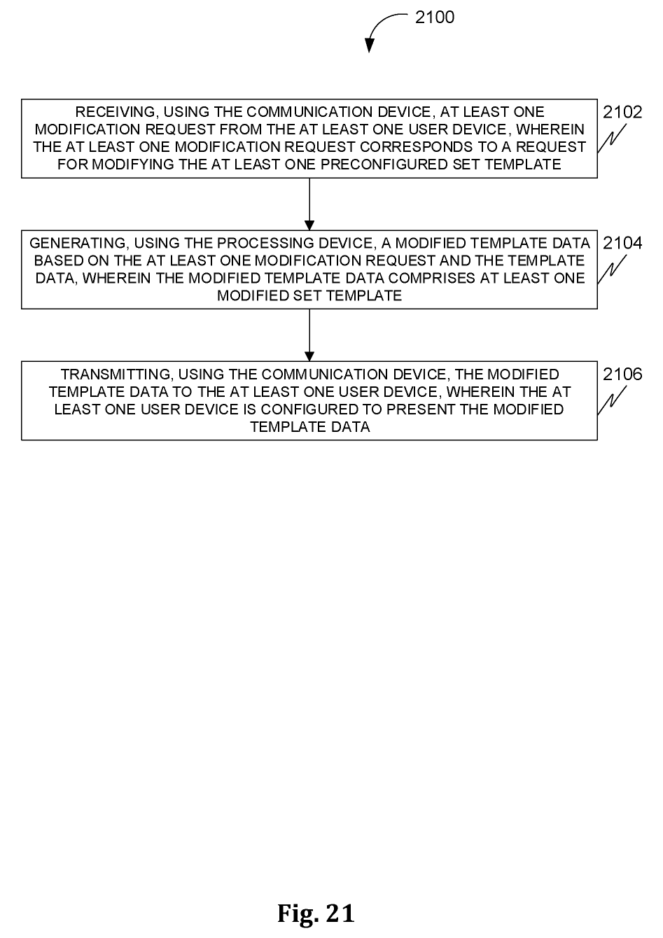

FIG. 21 illustrates a flowchart of a method 2100 of facilitating generation of data representing patterns in narrative media including generating, using the processing device 904, a modified template data, in accordance with some embodiments. Further, in some embodiments, the method 2100 further may include a step 2102 of receiving, using the communication device 902, one or more modification requests from the one or more user devices. Further, the one or more modification requests correspond to a request for modifying the one or more preconfigured set templates. Further, in some embodiments, the method 2100 further may include a step 2104 of generating, using the processing device 904, a modified template data based on the one or more modification requests and the template data. Further, the modified template data includes one or more modified set templates. Further, in some embodiments, the method 2100 further may include a step 2106 of transmitting, using the communication device 902, the modified template data to the one or more user devices. Further, the one or more user devices may be configured to present the modified template data.

In some embodiments, the modifying of the one or more preconfigured set templates includes modifying the at least one preconfigured set by one or more of adding one or more graphical cards.

In some embodiments, the one or more graphical cards include one or more of one or more opening cards and one or more closing cards.

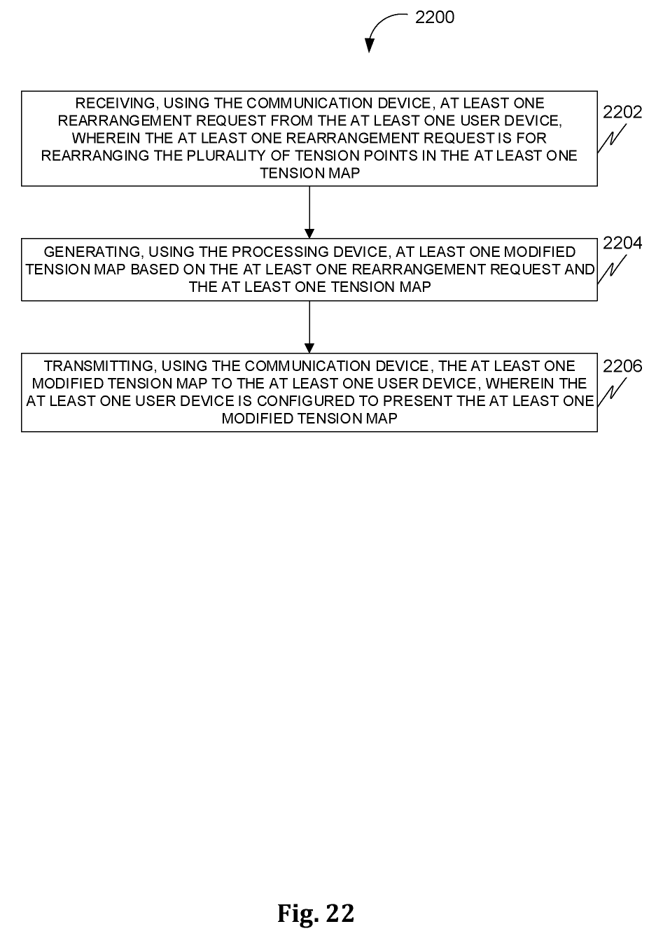

FIG. 22 illustrates a flowchart of a method 2200 of facilitating generation of data representing patterns in narrative media including generating, using the processing device 904, at least one modified tension map, in accordance with some embodiments. Further, in some embodiments, the method 2200 further may include a step 2202 of receiving, using the communication device 902, one or more rearrangement requests from the one or more user devices. Further, the one or more rearrangement requests may be for rearranging the two or more tension points in the one or more tension maps. Further, in some embodiments, the method 2400 further may include a step 2204 of generating, using the processing device 904, one or more modified tension maps based on the one or more rearrangement requests and the one or more tension maps. Further, in some embodiments, the method 2200 further may include a step 2206 of transmitting, using the communication device 902, the one or more modified tension maps to the one or more user devices. Further, the one or more user devices may be configured to present the one or more modified tension maps.

In some embodiments, the generating of the one or more modified tension maps includes rearranging two or more graphical cards in the one or more tension maps. Further, the two or more graphical cards represent the two or more tension points of the one or more stories.

In some embodiments, the method 2200 may further include storing, using a storage device, each of the one or more tension maps and the one or more modified tension maps in a database to track two or more versions of a tension map.

In some embodiments, the analytics data indicates one or more of a number of tension sets of the one or more stories, a number of types of the tension sets, a tension point per scene of the one or more stories, a tension point per chapter of the one or more stories, and a tension point per episode of the one or more stories.

In some embodiments, the one or more tension maps include a first tension set and a second tension set. Further, the two or more tension points belonging to the first tension set may be characterized by a first color. Further, the two or more tension points belonging to the first tension set may be characterized by a second color. Further, the first color may be different from the second color.

In some embodiments, the presenting of the one or more tension maps includes presenting the one or more tension maps based on one or more presentation functions associated with the one or more user devices.

In some embodiments, the one or more presentation functions include one or more of a play function, a rewind function, a forward function, and a presentation status indicator.

In some embodiments, the presenting of the one or more tension maps includes presenting the two or more tension points in a horizontal arrangement.

In some embodiments, the method 300 may further include generating, using the processing device 904, the one or more metadata of the one or more portions using the AI model based on the analyzing of the one or more story data. Further, the determining of the two or more tension points may be further based on the generating of the one or more metadata.

In some embodiments, the one or more stories include an interactive story. Further, the AI model may be configured to update the one or more metadata based on one or more user interactions with the one or more tension maps.

In some embodiments, the one or more stories include an interactive story comprising a branched story. Further, the one or more metadata includes one or more of an inflection point identifier, a branch identifier, an endpoint identifier, a path identifier, and a tier identifier. Further, the one or more tension maps may include a three dimensional model including two or more linear paths. Further, the one or more user devices may be configured to allow the one or more users to navigate through the branched story by one or more of sliding and flipping the two or more linear paths of the three dimensional model.

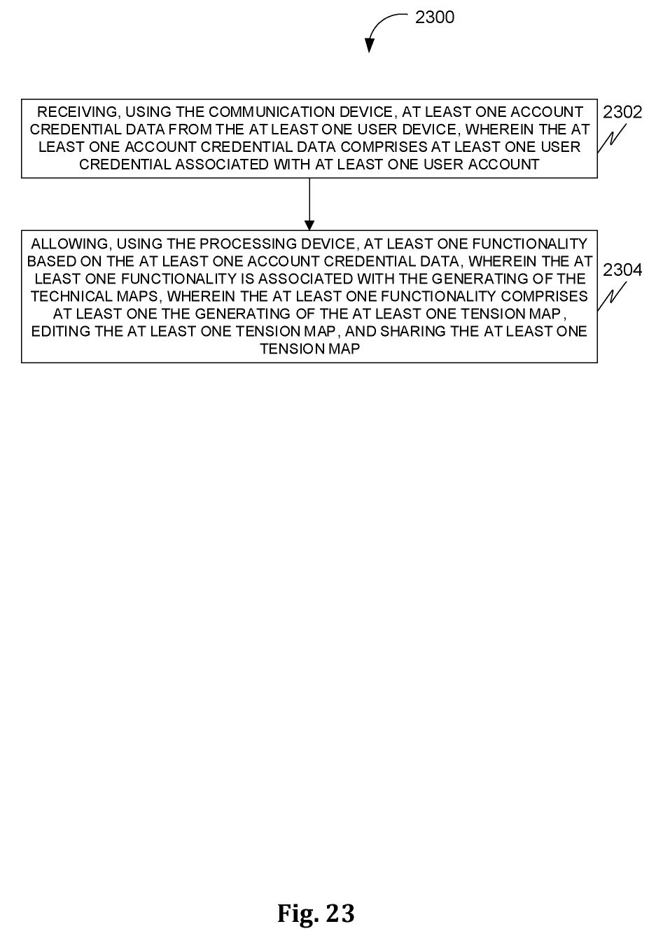

FIG. 23 illustrates a flowchart of a method 2300 of facilitating generation of data representing patterns in narrative media including allowing, using the processing device 904, at least one functionality, in accordance with some embodiments. Further, in some embodiments, the method 2300 further may include a step 2302 of receiving, using the communication device 902, one or more account credential data from the one or more user devices. Further, the one or more account credential data includes one or more user credentials associated with one or more user accounts. Further, in some embodiments, the method 2300 further may include a step 2304 of allowing, using the processing device 904, one or more functionalities based on the one or more account credential data. Further, the one or more functionalities may be associated with the generating of the technical maps. Further, the one or more functionalities include at least one of the generating of the one or more tension maps, editing the one or more tension maps, and sharing the one or more tension maps.

In some embodiments, the type of the one or more tensions corresponds to one or more of beginning of a conflict, and resolving of the conflict.

In some embodiments, the clutch type corresponds to one or more of a problem and a solution, a setup and a payoff, a mystery and a reveal, a conflict and a resolution, an expectation set and an expectation reveal, a risk and a safety, an attempt and a success, and an attempt and a fail.

FIG. 24 illustrates a Graphical User Interface (GUI) 2400 of a system of facilitating generation of data representing patterns in narrative media, in accordance with some embodiments. Further, the GUI 2400 displays a story upload function of the system. Further, the GUI 2400 displays a story in a text format 2402 with a plurality of mapping functions. Further, the plurality of mapping functions includes highlighting text section 2404, selecting a tension point type 2406, selecting clutch type 2408, entering tension description 2410, and creating tension tag name 2412. Further, the GUI 2400 displays a review function 2414 and mapping function 2416.

FIG. 25 illustrates a story focus Graphical User Interface (GUI) 2500 of the system of facilitating generation of data representing patterns in narrative media, in accordance with some embodiments. Further, the story focus GUI 2500 displays a plurality of tension point descriptions (2502 – 2510) of a plurality of tension points. Further, each of the plurality of tension points may possess one or more connections to other tension points. Further, the story focus GUI 2500 displays a focus function 2512, a note function 2514, and a parking lot function 2516. Further, the focus function 2512 includes a story focus function 2520 and a tension set focus function 2518. Further, the story focus GUI 2500 displays a tension point description of each of a plurality of tension points (2522 – 2528) of the story.

FIG. 26 illustrates a tension set focus Graphical User Interface (GUI) 2600 of the system of facilitating generation of tension maps, in accordance with some embodiments. Further, the tension set focus GUI 2600 displays a plurality of tension sets (2602 – 2608). Further, the tension set focus GUI 2600 displays a tension point description of each of a plurality of tension points (2522 and 2610) of a tension set 2602.

FIG. 27 illustrates a Graphical User Interface (GUI) 2700 of the system facilitating generation of data representing patterns in narrative media, displaying a note function, in accordance with some embodiments. Further, the GUI 2700 displays a font function 2702 and an input field 2704 of the note function 2514.

FIG. 28 illustrates a Graphical User Interface (GUI) 2800 of the system facilitating generation of data representing patterns in narrative media, displaying a recorded user note, in accordance with some embodiments. Further, the GUI 2800 displays a plurality of note cards 2808 in a vertical arrangement. Further, the GUI 2800 displays a content 2806 of at least one of the plurality of note cards 2808 with an editing function 2802 and a font function 2804.

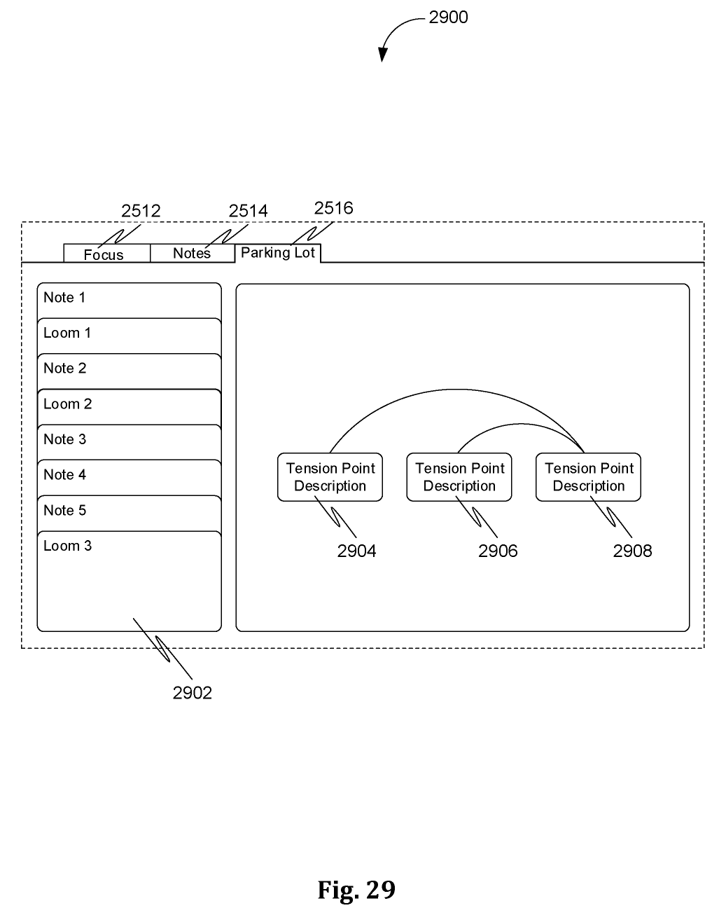

FIG. 29 illustrates a Graphical User Interface (GUI) 2900 of the system facilitating generation of data representing patterns in narrative media, displaying a parking lot function, in accordance with some embodiments. Further, the GUI 2900 displays the parking lot function 2516 displaying a plurality of notes and a plurality of tension sets 2902 in a vertical arrangement. Further, the GUI 2900 displays a plurality of tension point descriptions (2904 – 2908) of at least one of the plurality of tension sets 2902 and one or more connections between the plurality of tension point descriptions (2904 – 2908).

FIG. 30 illustrates a first creator suite Graphical User Interface (GUI) 3000 of the system of facilitating generation of data representing patterns in narrative media, in accordance with some embodiments. Further, the first creator suite GUI 3000 displays a list of tension sets 3002 and a new tension set. Further, the new tension set comprises a plurality of graphical cards (3004 and 3006) and a connection 3008 between the plurality of graphical cards (3004 and 3006).

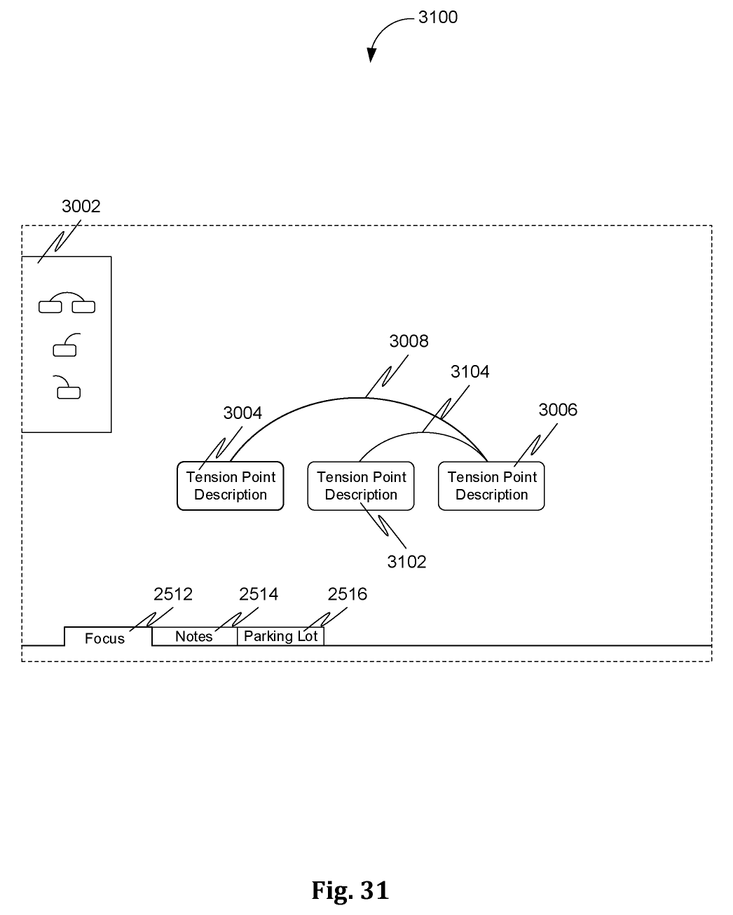

FIG. 31 illustrates a second creator suite Graphical User Interface (GUI) 3100 of the system of facilitating generation of data representing patterns in narrative media, in accordance with some embodiments. Further, the second creator suite GUI 3100 displays a new graphical card 3102 added to the new tension set and a connection 3104 of the new graphical card 3102.

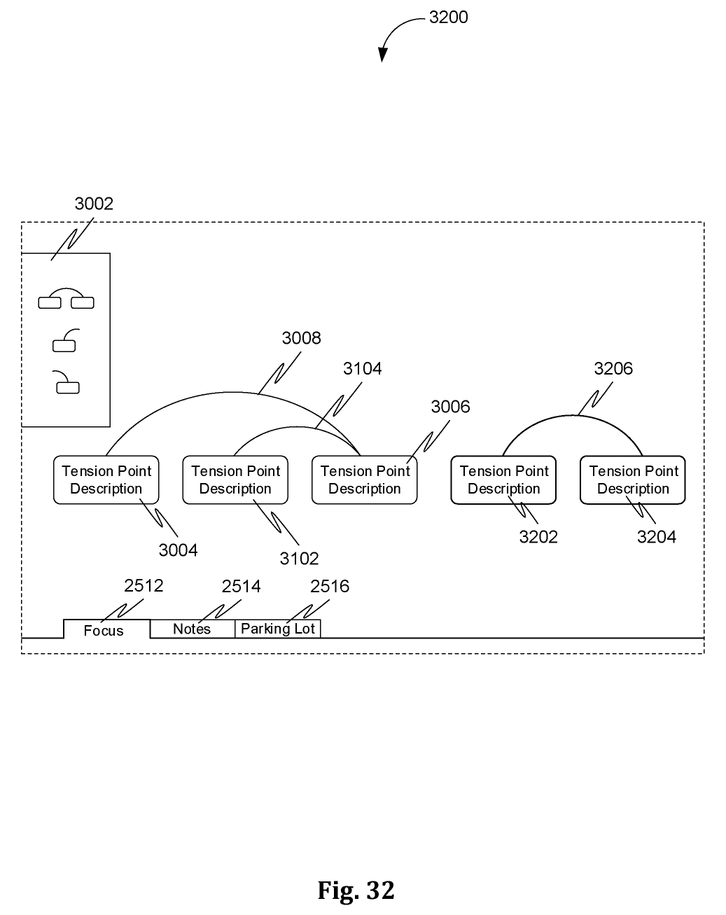

FIG. 32 illustrates a third creator suite Graphical User Interface (GUI) 3200 of the system of facilitating generation of data representing patterns in narrative media, in accordance with some embodiments. Further, the third creator suite GUI 3200 displays an additional tension set comprising a plurality of additional graphical cards (3202 and 3204) and an additional connection 3206 between the plurality of additional graphical cards (3202 and 3204).

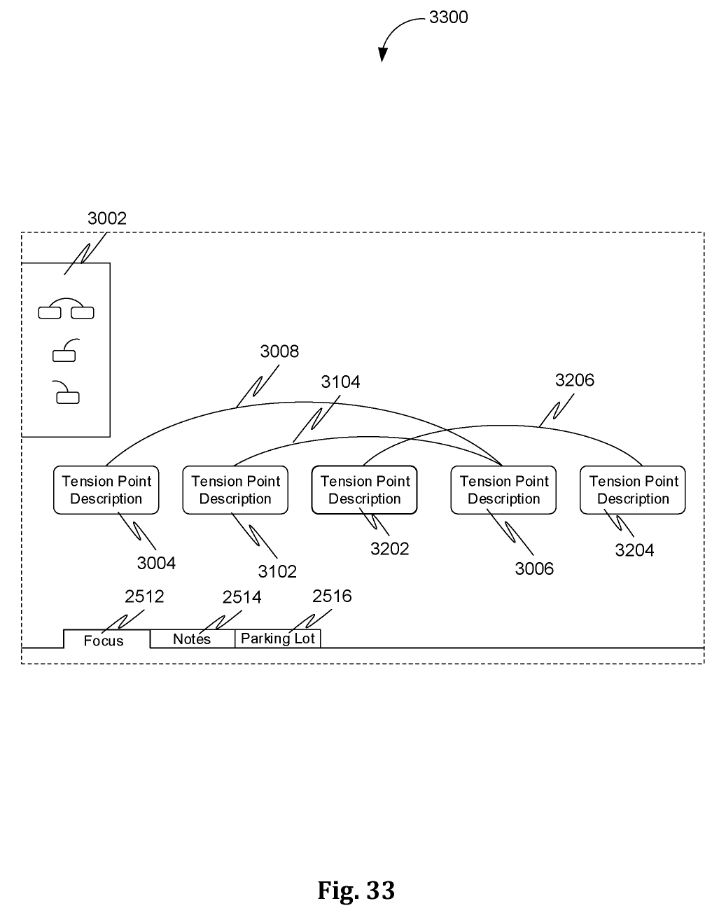

FIG. 33 illustrates a fourth creator suite Graphical User Interface (GUI) 3300 of the system of facilitating generation of data representing patterns in narrative media, in accordance with some embodiments. Further, the fourth creator suite GUI 3300 displays a movement of an additional graphical card 3202.

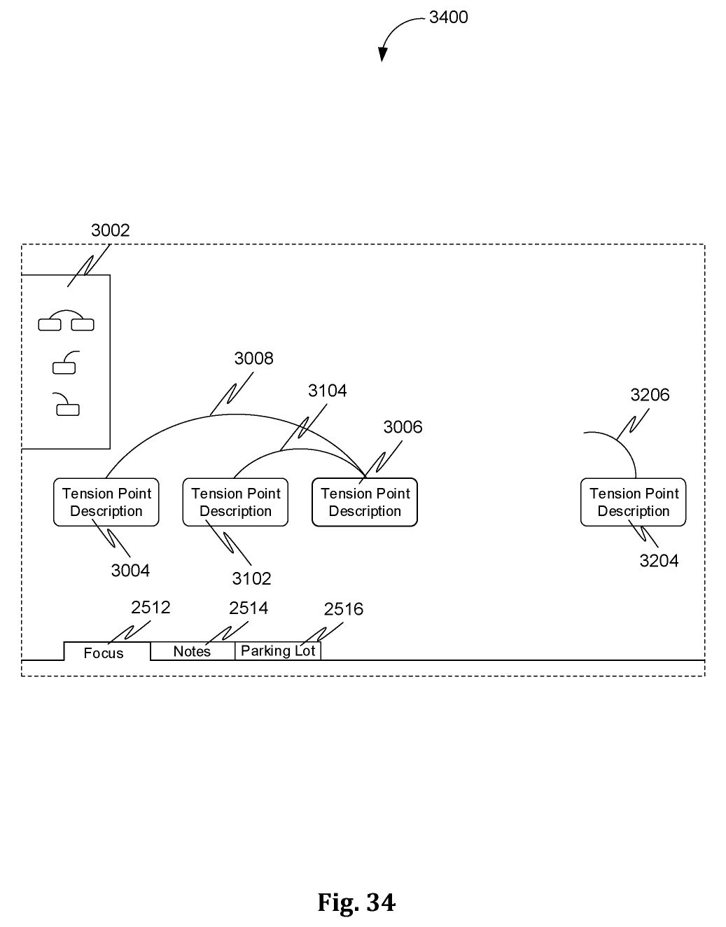

FIG. 34 illustrates a fifth creator suite Graphical User Interface (GUI) 3400 of the system of facilitating generation of data representing patterns in narrative media, in accordance with some embodiments. Further, the fifth creator suite GUI 3400 displays a deletion of the additional graphical card 3202.

FIG. 35 illustrates an open-close tension set 3500 of the system of facilitating generation of data representing patterns in narrative media, in accordance with some embodiments. Further, the open-close tension set 3500 includes an open tension point 3502, a close tension point 3504, and a connection 3506 between the open tension point 3502 and the close tension point 3504.

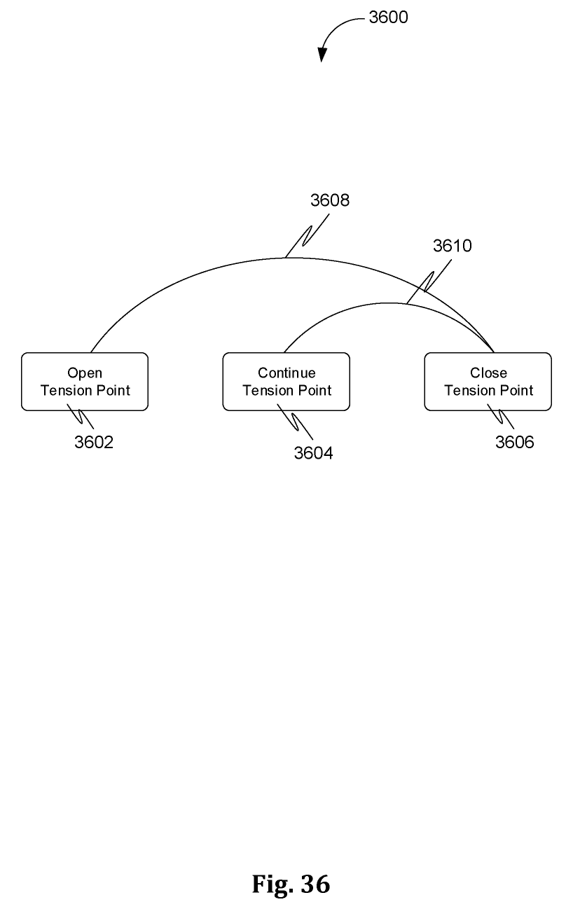

FIG. 36 illustrates an open-continue-close tension set 3600 of the system of facilitating generation of data representing patterns in narrative media, in accordance with some embodiments. Further, the open-continue-close tension set 3600 includes an open tension point 3602, a continue tension point 3604, and a close tension point 3606. Further, the open-continue-close tension set 3600 includes a connection 3608 between the open tension point 3602 and the close tension point 3606, and a connection 3610 between the continue tension point 3604 and the close tension point 3606.

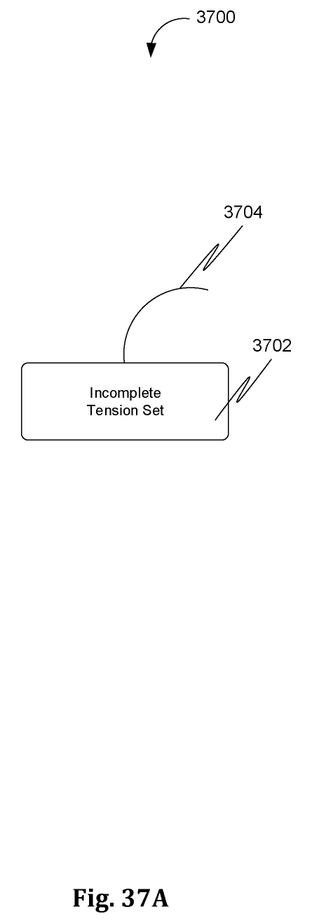

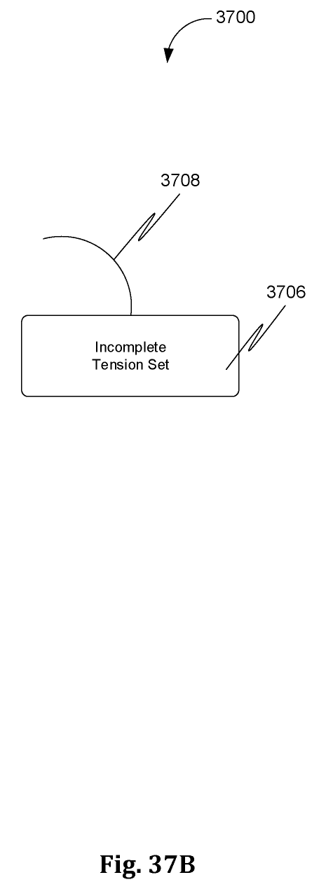

FIG. 37A and 37B is a first representation and a second representation of an incomplete tension set 3700 of the system of facilitating generation of data representing patterns in narrative media, in accordance with some embodiments. Further, the first representation of the incomplete tension set 3700 includes a graphical card 3702 and a first unconnected line 3704. Further, the second representation of the graphical card 3700 includes an incomplete tension set 3706 and a second unconnected line 3708.

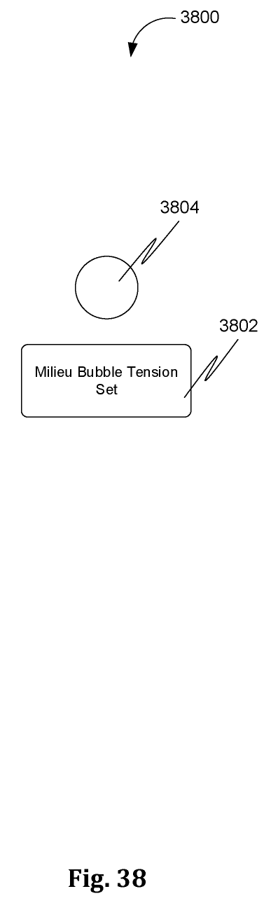

FIG. 38 illustrates a milieu bubble tension set 3800 of the system of facilitating generation of data representing patterns in narrative media, in accordance with some embodiments. Further, the milieu bubble tension set 3800 includes a graphical card 3802 and a circle 3804 placed above the graphical card 3802.

FIGS. 39A-39D illustrates a mobile Graphical User Interface (GUI) 3900 depicting a transition of tension points, in accordance with some embodiments. Further, the mobile GUI 3900 displays a display function 3904 with a first graphical card 3902 of a first tension point. Further, the mobile GUI 3900 displays a transition from the first graphical card 3902 to a second graphical card 3904 of a subsequent tension point. Further, a user interaction with the display function 3904 facilitates the transition of the tension points. Further, the first graphical card 3902 and the second graphical card 3904 are presented as a sequence of layered cards. Further, the mobile Graphical User Interface (GUI) 3900 allows a user to navigate through a linear story by sliding between graphical cards of the tension points.

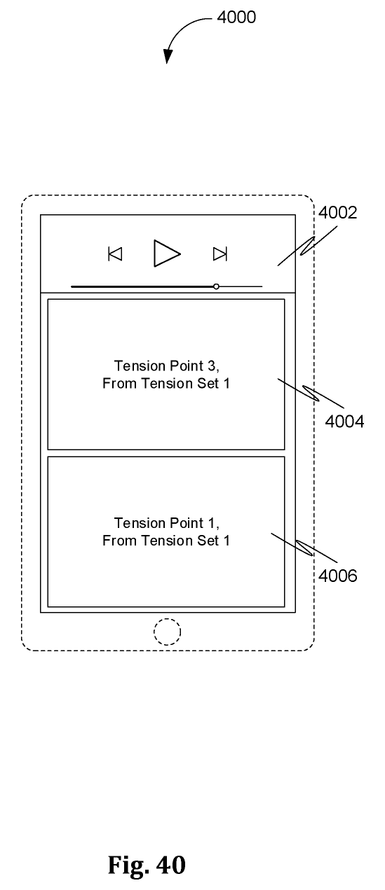

FIG. 40 illustrates a mobile Graphical User Interface (GUI) 4000 displaying a graphical card, in accordance with some embodiments. Further, the mobile GUI 4000 displays a plurality of graphical cards (4004 and 4006) of a tension set with a display function 4002.

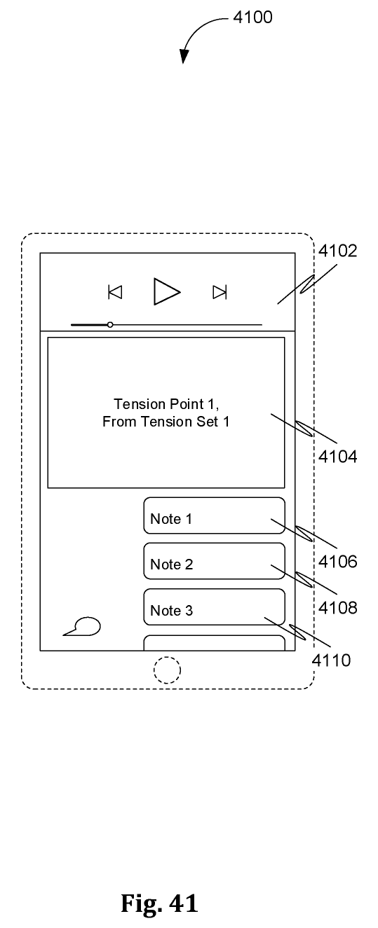

FIG. 41 illustrates a mobile Graphical User Interface (GUI) 4100 displaying a user note, in accordance with some embodiments. Further, the mobile GUI 4100 displays a graphical card 4104 and a plurality of user notes (4106 – 4110) associated with the graphical card 4104. Further, the mobile GUI 4100 displays a display function 4102.

FIG. 42 illustrates a Graphical User Interface (GUI) 4200 of the system of facilitating generation of data representing patterns in narrative media, displaying a three-dimensional model, in accordance with some embodiments. Further, GUI 4200 displays a tension map of a branched narrative story. Further, the tension map includes the three-dimensional model including a plurality of graphical cards (4202 – 4234) and a plurality of connections between the plurality of graphical cards (4202 – 4234).

Although the invention has been explained in relation to its preferred embodiment, it is to be understood that many other possible modifications and variations can be made without departing from the spirit and scope of the invention as hereinafter claimed.

What is claimed is:

1. A method of facilitating generation of data representing patterns in narrative media, the method comprising:
receiving, using the communication device, at least one story data from at least one user device, wherein the at least one story data indicates at least one story;
analyzing, using a processing device, the at least one story data;
determining, using the processing device, a plurality of tension points of the at least one story based on the analyzing of the at least one story, wherein the plurality of tension points corresponds to a plurality of portions of the at least one story creating a narrative tension for at least one individual;
generating, using the processing device, at least one tension map of the at least one story based on the determining of the plurality of tension points, wherein the at least one tension map corresponds to a graphical representation indicating the plurality of tension points and at least one relationship between the plurality of tension points; and
transmitting, using the communication device, the at least one tension map to the at least one user device associated with at least one user, wherein the at least one user device is configured to present the at least one tension map.

2. The method of claim 1, wherein the analyzing of the at least one story data comprises analyzing the at least one story data using an Artificial Intelligence (AI) model, wherein the AI model is configured to analyzing the at least one story data based on a plurality of predefined tension data, wherein the plurality of predefined tension data corresponds to definitions of a plurality of tension types, wherein the determining of the plurality of tension points is based on the analyzing of the at least one story data using the AI model.

3. The method of claim 1 further comprising:
receiving, using the communication device, at least one metadata of at least one portion of the at least one story from the at least one user device; and
analyzing, using the processing device, the at least one metadata, wherein the determining of the plurality of tension points of the at least one story is further based on the analyzing of the at least one metadata.

4. The method of claim 1, wherein the at least one tension map comprises a plurality of graphical cards representing the plurality of tension points, wherein the at least one tension map further comprises at least one line connecting the plurality of graphical cards, wherein the at least one line indicates the at least one relationship between the plurality of tension points.

5. The method of claim 1 further comprising:
analyzing, using the processing device, the plurality of tension points;
determining, using the processing device, the at least one relationship between the plurality of tension points based on the analyzing of the plurality of tension points; and
obtaining, using the processing device, at least one tension set based on the determining of the at least one relationship, wherein the at least one tension set comprises the plurality of tension points possessing the at least one relationship with others of the plurality of tension points, wherein the generating of the at least one tension map is further based on the obtaining of the at least one tension set, wherein the at least one tension map indicates the at least one relationship between the plurality of tensions points of the at least one tension set.

6. The method of claim 1 further comprising:
generating, using the processing device, a focus suggestion data, wherein the focus suggestion data comprises a plurality of focus suggestions for viewing the at least one tension map in a plurality of perspectives;
transmitting, using the communication device, the focus suggestion data to the at least one user device, wherein the at least one user device is further configured to present the focus suggestion data, wherein the at least one user device is further configured to generate at least one preference data based on a user selection on at least one of the plurality of focus suggestions; and
receiving, using the communication device, the at least one preference data from the at least one user device, wherein the at least one preference data indicates at least one of the plurality of focus suggestions, wherein the generating of the at least one tension map is further based on the at least one preference data.

7. The method of claim 6, wherein the plurality of focus suggestions comprises a story focus suggestion and a tension set focus suggestion, wherein the at least one preference data indicates the story focus suggestion, wherein the at least one tension map represents the plurality of tension points of the at least one story and the at least one relationship between the plurality of tension points.

8. The method of claim 6, wherein the plurality of focus suggestions comprises a story focus suggestion and a tension set focus suggestion, wherein the at least one preference data indicates the tension set focus suggestion, wherein the at least one tension map represents the plurality of tension points of at least one tension set of the at least one story and the at least one relationship between the plurality of tension points.

9. The method of claim 1 further comprising:
receiving, using the communication device, at least one user request from the at least one user device, wherein the at least one user request is for creating the at least one tension map;
generating, using the processing device, a template data based on the at least one user request, wherein the template data comprises at least one preconfigured set template for the creating of the at least one tension map; and
transmitting, using the communication device, the template data to the at least one user device, wherein the at least one user device is configured to present the template data, wherein the at least one user device is further configured to generate a template selection data based on a user selection on the at least one preconfigured set template, wherein the at least one user device is further configured to transmit the template selection data to the communication device.

10. The method of claim 2 further comprising:
generating, using the processing device, at least one edit suggestion data using the AI model based on at least one of the at least one tension map and the at least one story, wherein the at least one edit suggestion data corresponds to a suggestion to modify at least one of the at least one tension map and the at least one story; and
transmitting, using the processing device, the at least one edit suggestion data to the at least one user device.

11. A system for facilitating generation of data representing patterns in narrative media, the system comprising:
a communication device configured for:
receiving at least one story data from at least one user device, wherein the at least one story data indicates at least one story; and
transmitting at least one tension map to the at least one user device associated with at least one user, wherein the at least one user device is configured to present the at least one tension map; and
a processing device communicatively coupled with the communication device, wherein the processing device is configured for:
analyzing the at least one story data;
determining a plurality of tension points of the at least one story based on the analyzing of the at least one story, wherein the plurality of tension points corresponds to a plurality of portions of the at least one story creating a narrative tension for at least one individual; and
generating the at least one tension map of the at least one story based on the determining of the plurality of tension points, wherein the at least one tension map corresponds to a graphical representation indicating the plurality of tension points and at least one relationship between the plurality of tension points;

12. The system of claim 11, wherein the analyzing of the at least one story data comprises analyzing the at least one story data using an Artificial Intelligence (AI) model, wherein the AI model is configured to analyze the at least one story data based on a plurality of predefined tension data, wherein the plurality of predefined tension data corresponds to definitions of a plurality of tension types, wherein the determining of the plurality of tension points is based on the analyzing of the at least one story data using the AI model.

13. The system of claim 11, wherein the communication device is further configured for receiving at least one metadata of at least one portion of the at least one story from the at least one user device, wherein the processing device is further configured for analyzing the at least one metadata, wherein the determining of the plurality of tension points of the at least one story is further based on the analyzing of the at least one metadata.

14. The system of claim 11, wherein the at least one tension map comprises a plurality of graphical cards representing the plurality of tension points, wherein the at least one tension map further comprises at least one line connecting the plurality of graphical cards, wherein the at least one line indicates the at least one relationship between the plurality of tension points.

15. The system of claim 11, wherein the processing device is further configured for:
analyzing the plurality of tension points;
determining the at least one relationship between the plurality of tension points based on the analyzing of the plurality of tension points; and
obtaining at least one tension set based on the determining of the at least one relationship, wherein the at least one tension set comprises the plurality of tension points possessing the at least one relationship with others of the plurality of tension points, wherein the generating of the at least one tension map is further based on the obtaining of the at least one tension set, wherein the at least one tension map indicates the at least one relationship between the plurality of tensions points of the at least one tension set.

16. The system of claim 11, wherein the processing device is further configured for generating a focus suggestion data, wherein the focus suggestion data comprises a plurality of focus suggestions for viewing the at least one tension map in a plurality of perspectives, wherein the communication device is further configured for:
transmitting the focus suggestion data to the at least one user device, wherein the at least one user device is further configured to present the focus suggestion data, wherein the at least one user device is further configured to generate at least one preference data based on a user selection on at least one of the plurality of focus suggestions; and
receiving the at least one preference data from the at least one user device, wherein the at least one preference data indicates at least one of the plurality of focus suggestions, wherein the generating of the at least one tension map is further based on the at least one preference data.

17. The system of claim 16, wherein the plurality of focus suggestions comprises a story focus suggestion and a tension set focus suggestion, wherein the at least one preference data indicates the story focus suggestion, wherein the at least one tension map represents the plurality of tension points of the at least one story and the at least one relationship between the plurality of tension points.

18. The system of claim 16, wherein the plurality of focus suggestions comprises a story focus suggestion and a tension set focus suggestion, wherein the at least one preference data indicates the tension set focus suggestion, wherein the at least one tension map represents the plurality of tension points of at least one tension set of the at least one story and the at least one relationship between the plurality of tension points.

19. The system of claim 11, wherein the communication device is further configured for:
receiving at least one user request from the at least one user device, wherein the at least one user request is for creating the at least one tension map; and
transmitting a template data to the at least one user device, wherein the at least one user device is configured to present the template data, wherein the at least one user device is further configured to generate a template selection data based on a user selection on at least one preconfigured set template, wherein the at least one user device is further configured to transmit the template selection data to the communication device, wherein the processing device is further configured for generating the template data based on the at least one user request, wherein the template data comprises the at least one preconfigured set template for the creating of the at least one tension map.

20. The system of claim 12, wherein the processing device is further configured for generating at least one edit suggestion data using the AI model based on at least one of the at least one tension map and the at least one story, wherein the at least one edit suggestion data corresponds to a suggestion to modify at least one of the at least one tension map and the at least one story, wherein the communication device is further configured for transmitting the at least one edit suggestion data to the at least one user device.
